(19) United States
(12) Patent Application Publication
(10) Pub. No.: US 2003/0203978 A1
(43) Pub. Date: Oct. 30, 2003

(54) Cosmetic compositions comprising silicone gels comprising entrapped, occluded or encapsulated pigments

(76) Inventors: Michael Joseph O'Brien, Clifton Park, NY (US); Suresh K. Rajaraman, Troy, NY (US)

Correspondence Address: Kenneth S. Wheelock, General Electric Company, GE Specialty Materials, One Plastics Avenue, Pittsfield, MA, 01201, US

(21) Appl. No.: 10/439,552

(22) Filed: May 16, 2003

Related U.S. Application Data
(63) Continuation-in-part of application No. 10/393,858, filed on Mar. 21, 2003.
Application No. 10/393,858 is a continuation-in-part of application No. 09/858,795, filed on May 16, 2001, now Pat. No. 6,538,061.

(51) Int. Cl. C09K 3/00

(52) U.S. Cl. 516/77

(57) ABSTRACT

Methods for making pigmented cosmetic formulations comprising a silicone gel comprising an entrapped, occluded or encapsulated pigment.

### CROSS-REFERENCE TO RELATED APPLICATIONS

The instant application is a Continuation-In-Part application of U.S. Ser. No. 10/393,858 filed Mar. 21, 2003 which is a Continuation-In-Part application of U.S. Ser. No. 09/858,795 filed May 16, 2001 now U.S. Pat. No. 6,538,061.

### FIELD OF THE INVENTION

The present invention relates to methods of making cosmetic compositions comprising silicone polymer networks comprising entrapped or encapsulated pigments wherein said pigments are entrapped or encapsulated by the silicone polymer network and methods for making such silicone compositions. Preferably these compositions also exhibit the desirable property of forming films. In a specifically preferred embodiment, the invention relates to personal care and/or make-up composition for the skin of both the face and the human body, for the mucous membranes such as the lips and the inside of the lower eyelids, or alternatively for the superficial body growths such as the eyelashes, the eyebrows, the nails and the hair. This composition may be provided in particular in the form of a product cast as a stick or in a dish such as lipsticks or lip balms, cast foundations, concealers, eyeshadows or blushers, in the form of a paste or a cream which is fluid to a greater or lesser degree such as fluid foundations or lipsticks, eyeliners, compositions for protecting against sunlight or for coloring the skin.

### BACKGROUND OF THE INVENTION

The personal care industry thrives on being able to deliver multiple performance products based on mixtures of several components, with each having performance characteristics important to or desirable in the final formulation. One desirable characteristic is the ability to provide a silky initial feel derived from low molecular weight silicones, such as for example, octamethylcyclotetrasilioxane or decamethylcyclopentasiloxane, in the formulation while maintaining a high, but shear-thinnable viscosity. While these low molecular weight silicones provide the desired feel characteristics, they are also low viscosity, highly flowable liquids. Thus they are not easily held in a formulation, preferring rather to separate and flow out of a given container or flow uncontrollably across the skin when used in a specific application. Further, it desirable to achieve an initial silky feel while providing a smooth, low-residue feel upon dry-down. Polymeric silicone gels prepared in volatile silicone have been found to deliver desirable initial feel of volatile, low viscosity silicones to formulations while at the same time provide high viscosity and a smooth silky feel on dry-down, see for example, U.S. Pat. Nos. 5,760,116, 5,493,041 and 4,987,169.

### SUMMARY OF THE INVENTION

The present invention provides for a method of making a pigmented cosmetic composition comprising:

(a) preparing a silicone gel comprising an entrapped, occluded or encapsulated pigment; and (b) dispersing the silicone gel in a dispersant medium. More particularly the present invention provides for a method of making a colored cosmetic composition wherein the silicone gel comprising entrapped, occluded or encapsulated pigment is selected from the group of gels consisting of:

(i) a gel formed from a silicone and a hydrosilylation compatible solvent wherein said silicone is prepared by the hydrosilylation of a linear alkenyl polyorganosiloxane and a hydride resin;

(ii) a gel formed as a reaction product of an epoxy functional hydrido-siloxane said reaction product being formed in an epoxy-gel formation compatible solvent;

(iii) a gel formed from a silicone and a hydrosilylation compatible solvent wherein said silicone is prepared by the hydrosilylation of a linear hydrogen polyorganosiloxane and an alkenyl resin;

(iv) a gel formed from a silicone and a hydrosilylation compatible solvent wherein said silicone is prepared by the hydrosilylation of a linear hydrogen polyorganosiloxane and a linear alkenyl polyorganosiloxane;

(v) a gel formed from a silicone and hydrosilylation compatible solvent wherein said silicone is prepared by the hydrosilylation of a hydrogen polyorganosiloxane resin and an alkenyl polyorganosiloxane resin;

(vi) a gel formed from a silicone and a hydrosilylation compatible solvent wherein said silicone is prepared by the hydrosilylation of a linear hydrogen organopoly-siloxane having two or more hydride functionalities per molecule and an α,ω reactive organic molecule possessing two or more reactive functionalities per molecule; and

(vii) a gel formed as a reaction product of a vinyl functional hydrido-siloxane in a hydrosilylation compatible solvent.

This present invention provides for a new method for preparation of swollen cross-linked silicone network compositions by incorporating the pigments prior to the cross-linking reaction, thus entrapping, occluding or encapsulating the pigments within the silicone network. Currently, when pigments are used along with swollen cross-linked silicone materials, they are physically mixed resulting in independent gel and pigment phases. This can, especially in the case of solid inorganic pigments, cause reagglomeration resulting in color shift and inhomogeneities.

The present invention also provides for colored cosmetic compositions comprising entrapped or encapsulated colored materials or pigments selected from the group consisting of FD&C blue no. 1, FD&C green no. 3, FD&C red no. 4, FD&C red no. 40, FD&C yellow no. 5, FD&C yellow no. 6, D&C blue no. 4, D&C brown no. 1, D&C green no. 5, D&C green no. 6, D&C green no. 8, D&C orange no. 4, D&C orange no. 5, D&C orange no. 10, D&C orange no. 11, D&C red no. 6, D&C red no. 7, D&C red no. 17, D&C red no. 21, D&C red no. 22, D&C red no. 27, D&C red no. 28, D&C red no. 30, D&C red no. 31, D&C red no. 33, D&C red no. 34, D&C red no. 36, D&C violet no. 2, D&C yellow no. 7, D&C yellow no. 8, D&C yellow no. 10, D&C yellow no. 11, Ext. D&C violet no. 2, Ext. D&C yellow no. 7, Iron oxide (red, yellow, black), Titanium dioxide (as rutile, anatase or brookite or any mixture thereof), Zinc oxide, Ultramarine, Bismuth oxychloride, Chromium oxide green, Chromium hydroxide green, Ferric ferrocyanide, Manganese violet, Guanine, Acid green no. 1, Pigment yellow no. 1, Pigment yellow no. 3, Solvent red no. 3, Solvent red no. 1, Pigment red no. 112, Pigment red no. 5, Acid orange no. 6, Acid red no. 14, Pigment red no. 68, Pigment red no. 48, Acid red no. 27 & Al lake, Acid red no. 18, Acid black no. 1, Pigment yellow no. 13, Solvent yellow no. 29, Acid red no. 73, Brilliant black no. 1, Acid blue no. 1, Acid blue no. 3, Basic violet no. 14, Basic blue no. 26, Acid green no. 50, Acid red no. 52, Acid violet no. 9, Acid red no. 51, Pigment violet no. 23, Pigment red no. 83, Acid blue no. 62, Acid blue no. 74, Pigment violet no. 19, Pigment blue no. 15, Direct blue no. 86, Pigment green no. 7, Bentonite, Barium sulfate, Calcium sulfate, Carbon black, Iron oxide (orange), Magnesium carbonate, Lactoflavin, Capsanthin, capsorubin, Beetroot red, Anthocyanins, Aluminum stearate, Zinc stearate, Magnesium stearate, Calcium stearate, Bromothymol blue, Bromocresol green, Acid red, Color Index (CI) 195, CI 18736, CI 18820, CI 18965, CI 20040, CI 21108, CI 24790, CI 27755, CI 40215, CI 40820, CI 40825, CI 40850, CI 42080, CI 42090, CI 42100, CI 42170, CI 42520, CI 42735, CI 45220, CI 45396, CI 45405, CI 50325, CI 50420, CI 60724, CI 61585, CI 69800, CI 69825, CI 71105, CI 73000, CI 73385, CI 73915, CI 74100, CI 75100, CI 75125, CI 75135, CI 75300, CI 77002, CI 77015, CI 77220, CI 77267, CI 77268:1, CI 77346, CI 77480, CI 77745, Beta carotene, Annatto, Caramel, Carmine, Chlorophyllin-copper complex, Henna, Aluminum powder, Bronze or copper powder, Silver, Mica, and Titanated mica.

### DETAILED DESCRIPTION OF THE INVENTION

Applicants have discovered that improved cosmetic formulations are obtained using silicone gels. These silicone gels may be prepared by a variety of synthetic routes. The cosmetic formulations of the present invention are all prepared by a variety of methods that incorporate homogenization or particle size reduction at one or more steps in the method of preparation. The preparation of the gels and their subsequent homogenization afford a convenient method of incorporating additional materials, so-called personal care ingredients (later defined) or active ingredients. The preferred methods of making the cosmetic compositions of the present invention involve: 1) the preparation of the silicone gel and addition or incorporation of personal care ingredients or active ingredients prior to homogenization or particle size reduction or 2) preparation of the silicone gel in the presence of personal care ingredients or active ingredients followed by homogenization.

Applicants have discovered that improved cosmetic compositions are obtained from pigmented and/or colored cosmetic compositions by the incorporation of a silicone gel comprising an entrapped, occluded or encapsulated pigment or colored material into the formulation of the colored cosmetic composition. As used herein, the terms entrapped, occluded or encapsulated are used more or less interchangeably and have a functional definition that when a gel containing encapsulated, occluded or entrapped pigment is contacted with a suitable solvent (e.g. paraffinic, aromatic, alcoholic, or mixtures thereof as well as other solvents such as water or acetone) and vigorously shaken or stirred allowing the mixture to come to rest should result in only two apparent phases, the gel phase and a supernatant solvent phase. In the event that three apparent phases result from such a qualitative experiment, a pigment phase, a gel phase and a supernatant solvent, the pigment is deemed to be encapsulated or entrapped if less than 10% by weight of the original pigment is recovered from such a process based on the amount of pigment originally introduced into the gel.

As used herein the phrase “silicone gel” refers to any silicone containing material that increases its volume upon contact with a low molecular weight solvent that may or may not be volatile wherein the solvent diffuses into the silicone containing material.

As used herein the terms polyorganosiloxane and organopolysiloxane are interchangeable one with the other.

As used herein the term “colored material” refers to physiologically acceptable dyes, pigments or other coloring material known to the cosmetic arts. The term “physiologically acceptable” is an accepted term of art and refers to topical application on humans.

As used herein the phrase “silicone containing material” refers to oligomers, polymers, copolymers, terpolymers and higher order polymers of silicon containing repeat units, copolymers and higher order interpolymers containing silicon repeat units with organic polymers. As used herein “organic polymers” means organic polymers wherein the repeat units do not contain silicon atoms in the polymeric backbone or chain. Thus for example, some silicones gels useful in the compositions of the present invention are polymeric, cross-linked, networks of organopolysiloxanes or block copolymers of organopolysiloxanes and organic polymers. The cross-linking of either type of network may be achieved by cross-linking units based on siloxanes comprising hydrido-, vinyl-, epoxy-, acrylate-, acetoxy-, or alkoxy-groups and the like and mixtures thereof and when such materials contain organic polymers as a component, organic compounds or oligomers capable of joining polymeric units together, e.g. terminal polyolefins, terminal polyolefinic ethers, acrylates, epoxides and the like and blends thereof. Silicone gels useful in the compositions of the present invention are exemplified in the following U.S. Pat. Nos. 4,987,169; 4,980,167; 5,760,116; 5,811,487 and 5,138,009 hereby and herewith specifically incorporated by reference.

As used herein the phrase one to eighty carbon atom monovalent hydrocarbon radical means a monovalent radical having from one to eighty carbon atoms and optionally from zero to eighty hetero atoms selected from the group consisting of oxygen, nitrogen, and sulfur.

As used herein the phrase “low molecular weight volatile solvent” refers to any solvent compatible with topical application to human beings without adverse effect thereto that has a vapor pressure between the temperatures of 0° C. and 100° C. ranging from about 1 mm Hg to 760 mm Hg.

The silicone gels enabled by the present invention may be prepared in a variety of chemically appropriate solvents (hereinafter defined and listed). Once prepared, the silicone gels may be dispersed in a variety of chemically appropriate solvents (hereinafter defined and listed).

While a variety of silicone gels may be prepared by condensation cure mechanisms, e.g. room temperature vulcanizable compositions, the following specific silicone gels are preferred.

Silicone Gel I.

The present invention may utilize a silicone gel composition comprising:

(A) a first silicone formed by the hydrosilylation product of

(1) a linear alkenyl polyorganosiloxane having the formula:

M^{vi}ₐDₓD^{vi}_{y}M₂₋ₐ

where the subscript x is a number greater than 10, the subscript y is a number ranging from zero to about 20, the subscript a is a number ranging from 0 to 2, subject to the limitation that a+y is within the range of from 1 to about 20, with M^{vi} defined as:

R¹R²R³SiO_{1/2}

where R¹ is a monovalent unsaturated hydrocarbon radical having from two to ten carbon atoms, and R² and R³ are each independently one to eighty carbon atom monovalent hydrocarbon radicals, with D defined as:

R⁴R⁵SiO_{2/2}

where R⁴ and R⁵ are each independently one to eighty carbon atom monovalent hydrocarbon radicals, with D^{vi} defined as:

D^{vi}=R⁶R⁷SiO_{2/2}

where R⁶ is a monovalent unsaturated hydrocarbon radical having from two to ten carbon atoms, and R⁷ is independently a one to eighty carbon atom monovalent hydrocarbon radical with M defined as

M=R⁸R⁹R¹⁰SiO_{1/2}

with R⁸, R⁹, and R¹⁰ each independently a one to eighty carbon atom monovalent hydrocarbon radical; and

(2) a hydride resin having the formula:

(M^{H}_{w}Q_{z})ⱼ

where Q has the formula SiO_{4/2} and with M^{H} defined as

H_{b}R¹¹_{3-b}SiO_{1/2}

where R¹¹ is a one to eighty carbon atom monovalent hydrocarbon radical where the subscript b is a number ranging from 1 to 3, with the subscripts w and z having a ratio of 0.5 to 4.0 respectively and the subscript j ranges from about 2.0 to about 100; wherein said hydrosilylation is conducted in the presence of

(3) a hydrosilylation compatible solvent preferably a silicone having a viscosity below about 1,000 centistokes at 25° C. or a hydrosilylation compatible lipohilic phase (hereinafter also referred to as a hydrosilylation compatible solvent), thereby forming a gel; and

(B) a lipophilic phase or a silicone having a viscosity below about 1,000 centistokes at 25° C. (hereinafter also referred to as dispersant medium or media) wherein said hydrosilylation product is slurried in said lipophilic phase or said silicone and subjected to mixing with said lipophilic phase or said silicone; producing thereby a uniform mixture comprising said lipophilic phase or said silicone and said hydrosilylation product whereby said uniform mixture has a viscosity ranging from 500 to 500,000 centistokes at 25° C.

The silicone having a viscosity below about 1,000 centistokes at 25° C. is preferably selected from the group consisting of cyclic silicones having the formula:

D_{f}

where the subscript f is an integer ranging from about three to about 6 with D defined as:

R⁴R⁵SiO_{2/2}

where R⁴ and R⁵ are each independently one to eighty carbon atom monovalent hydrocarbon radicals,

the group of linear silicones having the formula:

M′D′ᵢM′

where D′ is defined as:

R⁴R⁵SiO_{2/2}

where R⁴ and R⁵ are each independently one to eighty carbon atom monovalent hydrocarbon radicals and M′ has the formula:

R¹²R¹³R¹⁴SiO_{1/2}

where R¹², R¹³ and R¹⁴ are each independently one to eighty carbon atom monovalent hydrocarbon radicals and the group of branched silicones having the formula:

T _{′} [symbol]D′ [symbol] M′ _{″}

[symbol]

where D′ and M′ are each independently selected and are as previously defined and

T=R²SiO_{3/2},

where R² is independently selected and is as previously defined and the subscript [symbol] ′ is at least 1, the subscript [symbol] ″ ranges from 0 to 3 [symbol] ′ and the subscript [symbol] is 0 or positive with all three subscripts chosen so that the viscosity of T _{′} [symbol]D′ [symbol] M′ _{″} [symbol] is 1,000 centipose or less at 25° C.

Silicone Gel II.

Other gels suitable for the compositions of the present invention comprise the reaction products of an epoxy functional hydrido-siloxane molecule having the following formula:

M_{α}M^{H}_{β}M^{E}_{χ}D_{δ}D^{H}_{ε}D^{E}_{φ}T_{γ}T^{H}_{η}T^{E}_{ι}Q_{κ}

where

M=R^{1′}R^{2′}R^{3′}SiO_{1/2};

M^{H}=R^{4′}R^{5′}HSiO_{1/2};

M^{E}=R^{6′}R^{7′}R^{E}SiO_{1/2};

D=R^{8′}R^{9′}SiO_{2/2};

D^{H}=R^{10′}HSiO_{2/2};

D^{E}=R^{11′}R^{E}SiO_{2/2};

T=R^{12′}SiO_{3/2};

T^{H}=HSiO_{3/2};

T^{E}=R^{E}SiO_{3/2};

and

Q=SiO_{4/2};

where R^{1′}, R^{2′}, R^{3′}, R^{8′}, R^{9′} and R^{12′} are independently monovalent hydrocarbon radicals having from one to sixty carbon atoms; R^{4′}, R^{5′} and R^{10′} are independently monovalent hydrocarbon radicals having from one to sixty carbon atoms or hydrogen; R^{6′}, R^{7′}, R^{11′} are independently monovalent hydrocarbon radicals having from one to sixty carbon atoms or R^{E}; each R^{E} is independently a monovalent hydrocarbon radical containing one or more oxirane moieties having from one to sixty carbon atoms; the stoichiometric subscripts α, β, χ, δ, ε, φ, γ, η, ι, and κ are either zero or positive subject to the following limitations: α+β+χ>1; β+ε+η>1; χ+φ+ι>1; β+ε+η>χ+φ+ι; and when δ+ε+φ+γ+η+ι+κ=0, α+β+χ=2.

The reaction product of an epoxy functional hydrido siloxane molecule is preferably prepared in an epoxy gel formation medium selected from a lipophilic phase or a silicone fluid selected from the group consisting of cyclic silicones having the formula:

D_{f}

where the subscript f is an integer ranging from about three to about 6 with D defined as:

R⁴R⁵SiO_{2/2}

where R⁴ and R⁵ are each independently one to eighty carbon atom monovalent hydrocarbon radicals,

the group of linear silicones having the formula:

M′D′ᵢM′

where D′ is defined as:

R⁴R⁵SiO_{2/2}

where R⁴ and R⁵ are each independently one to eighty carbon atom monovalent hydrocarbon radicals and M′ has the formula:

R¹²R¹³R¹⁴SiO_{1/2}

where R¹², R¹³ and R¹⁴ are each independently one to eighty carbon atom monovalent hydrocarbon radicals and the group of branched silicones having the formula:

T _{′} [symbol]D′ [symbol] M′ _{″}

[symbol]

where D′ and M′ are each independently selected and are as previously defined and T=R²SiO_{3/2}, where R² is independently selected and is as previously defined and the subscript [symbol] ′ is at least 1, the subscript [symbol] ″ ranges from 0 to 3 [symbol] ′ and the subscript [symbol] is 0 or positive with all three subscripts chosen so that the viscosity of T _{′} [symbol]D′ [symbol] M′ _{″} [symbol] is 1,000 centipose or less at 25° C.

Silicone Gel III.

The present invention may utilize a silicone gel composition comprising:

(A) a silicone formed by the hydrosilylation product of

(1) a linear hydrogen polyorganosiloxane having the formula:

M^{H}ₐDₓD^{H}_{y}M₂₋ₐ

where the subscript x is a number greater than 10, the subscript y is a number ranging from zero to about 20, the subscript a is a number ranging from 0 to 2, subject to the limitation that a+y is within the range of from 1 to about 20, with M^{H} defined as:

R¹R²R³SiO_{1/2}

where R¹ is hydrogen, R² and R³ are each independently one to eighty carbon atom monovalent hydrocarbon radicals, with D defined as:

R⁴R⁵SiO_{2/2}

where R⁴ and R⁵ are each independently one to eighty carbon atom monovalent hydrocarbon radicals, with D^{H} defined as:

D^{H}=R⁶R⁷SiO_{2/2}

where R⁶ is hydrogen and R⁷ is independently a one to eighty carbon atom monovalent hydrocarbon radical with M defined as

M=R⁸R⁹R¹⁰SiO_{1/2}

with R⁸, R⁹, and R¹⁰ each independently a one to eighty carbon atom monovalent hydrocarbon radical; and

(2) an alkenyl resin having the formula:

(M^{vi}_{w}Q_{z})ⱼ

where Q has the formula SiO_{4/2} and with M^{vi} defined as

R¹¹_{b}R¹²_{3-b}SiO_{1/2}

where R¹¹ is a monovalent unsaturated hydrocarbon radical having from two to ten carbon atoms, R¹² is a one to eighty carbon atom monovalent hydrocarbon radical where the subscript b is a number ranging from 1 to 3, with the subscripts w and z having a ratio of 0.5 to 4.0 respectively and the subscript j ranges from about 2.0 to about 100; wherein said hydrosilylation is conducted in the presence of

(3) a hydrosilylation compatible solvent preferably a silicone having a viscosity below about 1,000 centistokes at 25° C. or a hydrosilylation compatible lipohilic phase (hereinafter also referred to as hydrosilylation compatible solvent), thereby forming a gel; and

(B) a lipophilic phase or a silicone having a viscosity below about 1,000 centistokes at 25° C. (hereinafter also referred to as dispersant medium or media) wherein said hydrosilylation product is slurried in said lipophilic phase or said silicone and subjected to mixing with said lipophilic phase or said silicone; producing thereby a uniform mixture comprising said lipophilic phase or said silicone and said hydrosilylation product whereby said uniform mixture has a viscosity ranging from 500 to 500,000 centistokes at 25° C.

Silicone Gel IV

A first silicone being the hydrosilylation reaction product of a linear alkenyl organopolysiloxane (as previously defined) having two or more alkenyl functionalities per molecule as above with a linear hydrogen organopolysiloxane (as previously defined) having two or more hydrogen functionalities per molecule prepared as above in the presence of a hydrosilylation compatible solvent or silicone, D_{f}, M′D′ᵢM′ or TD′ [symbol] M′₃ where D_{f}, M′D′ᵢM′ and TD′ [symbol] M′₃ are as previously defined. The gel as prepared may then be slurried with a lipophilic phase or a silicone having a viscosity below about 1,000 centistokes at 25° C. (hereinafter also referred to as dispersant medium or media) wherein said hydrosilylation product is slurried in said lipophilic phase or said silicone and subjected to mixing with said lipophilic phase or said silicone; producing thereby a uniform mixture comprising said lipophilic phase or said silicone and said hydrosilylation product whereby said uniform mixture has a viscosity ranging from 500 to 500,000 centistokes at 25° C.

Silicone Gel V

A first silicone being the hydrosilylation reaction product of an alkenyl organopolysiloxane resin having two or more alkenyl functionalities per molecule having the formula

M^{vi}_{c}D_{d}D^{vi}ₑT_{g}T^{vi}ₖM_{2-c}M″_{g+k}

with a hydrogen organopolysiloxane resin having two or more hydrogen functionalities per molecule having the formula

M^{H}ₙDₚD^{H}ᵣTₛT^{H}ᵤMᵥM″ₛ₊ᵤ

where all the terms are as previously defined with

T=R¹⁶SiO_{3/2} where R¹⁶ is a one to eighty carbon atom monovalent hydrocarbon radicals;

T^{vi}=R¹⁷SiO_{3/2} where R¹⁷ is a monovalent unsaturated hydrocarbon radical having from two to forty carbon atoms;

T^{H}=HSiO_{3/2};

M″ is independently M^{H}, M^{vi} or M and the subscripts c, d, e, g, k, n, p, r, s, u, and v are either zero or positive subject to the limitations that g+k+s+u is ≧1; c+e+k≧2 and n+r+u≧2; prepared in a hydrosilylation compatible solvent and slurried in a lipophilic phase or a silicone having a viscosity below about 1,000 centistokes at 25° C. (hereinafter also referred to as dispersant medium or media) wherein said hydrosilylation product is slurried in said lipophilic phase or said silicone and subjected to mixing with said lipophilic phase or said silicone; producing thereby a uniform mixture comprising said lipophilic phase or said silicone and said hydrosilylation product whereby said uniform mixture has a viscosity ranging from 500 to 500,000 centistokes at 25° C.

Silicone Gel VI

A first silicone being the reaction product of a linear hydrido organopolysiloxane having two or more hydride functionalities per molecule with an α,ω reactive organic molecule possessing two or more reactive functionalities per molecule in the presence of a lipophilic phase or second silicone, D_{f}, M′D′ᵢM′ or TD′ [symbol] M′₃ where D_{f}, M′D′ᵢM′ and TD′ [symbol] M′₃ are as previously defined. The reactive functionalities of the α,ω reactive organic molecule possessing two or more functionalities per molecule are selected from the group of organic functional groups consisting of olefins, acetylenes, vinylethers, acrylates or acrylate esters (eg CH2═CHCOOROCOCH═CH2), and alcohols and the like. Thus the α,ω reactive organic molecule possessing two or more functionalities per molecule subtends a large group of organic molecules that includes α,ω-di-olefins, α,ω-olefins possessing a polyolefinic functionality, α,ω-di-acetylenes, α,ω-di-acetylenes possessing a polyacetylenic functionality, including side chain substituted variations where the side chains possess reactive functionality as herein defined. This gel is prepared in a hydrosilylation compatible solvent and slurried in a lipophilic phase or a silicone having a viscosity below about 1,000 centistokes at 25° C. (hereinafter also referred to as dispersant medium or media) wherein said hydrosilylation product is slurried in said lipophilic phase or said silicone and subjected to mixing with said lipophilic phase or said silicone; producing thereby a uniform mixture comprising said lipophilic phase or said silicone and said hydrosilylation product whereby said uniform mixture has a viscosity ranging from 500 to 500,000 centistokes at 25° C.

Silicone Gel VII

Other gels suitable for the compositions of the present invention comprise the reaction products of a vinyl functional hydrido-siloxane molecule having the following formula:

M_{a′}M^{vi}_{b′}M^{H}_{c′}D_{d′}D^{vi}_{e′}D^{H}_{f′}T_{g′}T^{vi}_{h′}T^{H}_{i′}Q_{j′}

where all the terms are as previously defined and the subscripts a′, b′, c′, d′, e′, f′, g′, h′, i′ and j′ are either 0 or a positive integer for well defined molecular species subject to the limitation b′+e′+h′ is greater than or equal to one and further subject to the limitation that c′+f′+i′ is greater than or equal to one. Mixtures of compounds where individual molecular species possess the formula, M_{a′}M^{vi}_{b′}M^{H}_{c′}D_{d′}D^{vi}_{e′}D^{H}_{f′}T_{g′}T^{vi}_{h′}T^{H}_{i′}Q_{j′}, will analyze for non-integral values of the subscripts because of the fact that it is a mixture and not a pure compound. Thus for mixtures of compounds possessing the formula, M_{a′}M^{vi}_{b′}M^{H}_{c′}D_{d′}D^{vi}_{e′}D^{H}_{f′}T_{g′}T^{vi}_{h′}T^{H}_{i′}Q_{j′}, the subscripts a′, b′, c′, d′, e′, f′, g′, h′, i′and j′ will be zero or positive. Compounds possessing the formula M_{a′}M^{vi}_{b′}M^{H}_{c′}D_{d′}D^{vi}_{e′}D^{H}_{f′}T_{g′}T^{vi}_{h′}T^{H}_{i′}Q_{j′} may be prepared by the procedures and methods disclosed in U.S. Pat. Nos. 5,698,654; 5,753,751; and 5,965,683 herewith specifically incorporated by reference. These materials may be reacted with the silicone precursors to the class II silicone gels previously defined herein or they may self-reacted in the presence of a noble metal hydrosilylation catalyst as is known in the art. These materials are prepared in a hydrosilyation compatible solvent and slurried in a lipophilic phase or a silicone having a viscosity below about 1,000 centistokes at 25° C. (hereinafter also referred to as dispersant medium or media) wherein said hydrosilylation product is slurried in said lipophilic phase or said silicone and subjected to mixing with said lipophilic phase or said silicone; producing thereby a uniform mixture comprising said lipophilic phase or said silicone and said hydrosilylation product whereby said uniform mixture has a viscosity ranging from 500 to 500,000 centistokes at 25° C.

Many types of noble metal catalysts for hydrosilylation (or SiH olefin addition reaction) are known and such noble metal catalysts may be used for the preparative reactions involved in making the compositions of the present invention. The most preferred noble metals are those of the platinum group metals, specifically rhodium and platinum. When optical clarity of the resulting addition product is required the preferred catalysts are those catalysts that are compounds that are soluble in the reaction mixture. One such platinum compound can be selected from those having the formula (PtCl₂Olefin) and H(PtCl₃Olefin) as described in U.S. Pat. No. 3,159,601, hereby incorporated by reference. The olefin shown in the previous two catalyst compound formulas can be almost any type of olefin but is preferably an alkenylene having from 2 to 8 carbon atoms, a cycloalkenylene have from 5 to 7 carbon atoms or styrene. Specific olefins utilizable in the above formulas are ethylene, propylene, the various isomers of butylene, octylene, cyclopentene, cyclohexene, cycloheptene, and the like.

A further platinum containing material usable in the compositions of the present invention is the cyclopropane complex of platinum chloride described in U.S. Pat. No. 3,159,662 hereby incorporated by reference.

Further the platinum containing material can be a complex formed from chloroplatinic acid with up to 2 moles per gram of platinum of a member selected from the class consisting of alcohols, ethers, aldehydes and mixtures of the above as described in U.S. Pat. No. 3,220,972 hereby incorporated by reference.

The catalysts are described in U.S. Pat. Nos. 3,715,334; 3,775,452; and 3,814,730 to Karstedt. Additional background concerning the art may be found at J. L. Spier, “Homogeneous Catalysis of Hydrosilation by Transition Metals, in Advances in Organometallic Chemistry, volume 17, pages 407 through 447, F. G. A. Stone and R. West editors, published by the Academic Press (New York, 1979). Persons skilled in the art can easily determine an effective amount of noble metal or platinum catalyst. Generally, an effective amount ranges from about 0.1 to 50 parts per million of the total organopolysiloxane composition.

The cosmetic compositions of the present invention are prepared in general by preparing the gels herein described, dispersing the gels in a dispersing medium and homogenizing the dispersed gels. The addition of pigments, personal care ingredients or active ingredients to the gels and the dispersant medium creates the cosmetic compositions of the present invention. The methods of the present comprise: 1) the addition of pigments, personal care ingredients or active ingredients to the gel precursors and forming the gels in the presence of pigments, personal care ingredients or active ingredients, dispersing the resultant gel in a dispersant medium and homogenizing the gel, the pigments, personal care ingredients or active ingredients, and the dispersant medium; 2) preparing the gel, adding thereto pigments, personal care ingredients or active ingredients either before or after dispersing the gel in a dispersant medium followed by homogenization; and 3) preparing the gel, dispersing it in a dispersant medium, homogenizing the gel in the dispersant medium and adding thereto pigments, personal care ingredients or active ingredients.

The gels of the present invention are prepared either in a hydrosilylation compatible medium or solvent or an epoxy-gel formation compatible medium or solvent depending on the chemical nature of the gel being prepared. Both classes of preparation media include silicone solvents, preferably a silicone selected from the group consisting of cyclic silicones having the formula

D_{f}

where the subscript f is an integer ranging from about three to about 6 with D defined as:

R⁴R⁵SiO_{2/2}

where R⁴ and R⁵ are each independently one to eighty carbon atom monovalent hydrocarbon radicals,

linear silicones having the formula:

M′D′ᵢM′

where D′ is defined as:

R⁴R⁵SiO_{2/2}

where R⁴ and R⁵ are each independently one to eighty carbon atom monovalent hydrocarbon radicals and M′ has the formula:

R¹²R¹³R¹⁴SiO_{1/2}

where R¹², R¹³ and R¹⁴ are each independently one to eighty carbon atom monovalent hydrocarbon radicals and branched silicones having the formula:

T _{′} [symbol]D′ [symbol] M′ _{″}

[symbol]

where D′ and M′ are each independently selected and are as previously defined and

T=R²SiO_{3/2}, where R² is independently selected and is as previously defined and the subscript [symbol] ′ is at least 1, the subscript [symbol] ″ ranges from 0 to 3 [symbol] ′ and the subscript [symbol] is 0 or positive with all three subscripts chosen so that the viscosity of T _{′} [symbol]D′ [symbol] M′ _{″} [symbol] is 1,000 centipose or less at 25° C.

The hydrosilylation compatible medium or solvent are selected from the group consisting of silicones and substituted silicones including: silicone oils of the desired viscosity from D₄ to 10,000 cps oils; polyethersilicone copolymers where the polyethers vary from 200 to 3000 molecular weight and may consist of alkylene oxide chains based on one, two or more types of monomer units such as ethylene oxide, propylene oxide or butylene oxide and may be attached to the silicone with 1 to six carbon chain, or through an silicone oxygen bond; polyester silicone copolymers; alkyl, aromatic or alkylaromatic substituted siloxanes; alkoxy substituted siloxanes including: substituted methoxy, ethoxy, propoxy, octyloxy, dodecanoxy, cetyryloxy or isostearyloxy siloxanes or other organically substituted siloxanes or siloxanes containing multiple organic substituents that are compatible with hydrosilylation reactions; hydro carbon solvents including: tetradecane, isododecane, isohexadecane, mineral oil, hydrogenate polydecene, apricot oil; ester solvents including: isopropyl myristate, diisopropyl adipate, isodecyl neopentanoate; ethers including: PPG-14 butyl ether, PPG 3 myristyl ether, ethoxylated alkylphenols; glyceryl esters of fatty acids including: sunflower oils, caprylic/capric triglyceride, C₁₀-18 triglyceride; fatty acid glycerides including: glyceryl stearate, glyceryl dioleate; non-volatile fluorinated oil including: fluorinated silicones and fluorinated esters; aromatic solvents including; benzene, toluene and alkylbenzenes; and alcohols including: isopropanol, octanol, dodecanol, hexadecanol, cetearyl alcohol, isostearyl alcohol, myristyl alcohol.

The epoxy gel formation compatible medium or solvent is primarily defined by solvent inertness and is preferably selected from the group of silicone solvents D_{f}, M′D′ᵢM′ or TD′ [symbol] M′₃ where D_{f}, M′D′ᵢM′ and TD′ [symbol] M′₃ are as previously defined and hydrocarbon solvents selected from the group consisting of paraffinic, iso-paraffinic, aromatic and alkyl aromatic solvents.

The compositions according to the present invention therefore advantageously comprise a stable dispersion of particles of at least one silicone in a dispersant medium preferably, a lipophilic phase, the lipophilic phase preferably selected from the group consisting of 1) physiologically acceptable liquid lipophilic or fatty phases and 2) silicone fluids selected from the group consisting of D_{f}, M′D′ᵢM′ or TD′ [symbol] M′₃ where D_{f}, M′D′ᵢM′ and TD′ [symbol] M′₃ are as previously defined.

These dispersions may in particular be provided in the form of nanoparticles of silicone gel in a stable dispersion in the said lipophilic or fatty phase. The nanoparticles are preferably of between 5 and 600 nm in size, given that above about 600 nm the dispersions of particles become much less stable. This size range includes all specific values and subranges therebetween, including 10, 25, 50, 100, 200, 300, 400 and 500 nm.

The liquid lipophilic or fatty phase in which the siloxane or silicone polymer may be dispersed may consist of any cosmetically or dermatologically acceptable, and more generally physiologically acceptable, oil chosen in particular from oils of inorganic, animal, plant or synthetic origin, carbonaceous oils, hydrocarbon oils, fluorinated oils and/or silicone oils, alone or in the form of a mixture insofar as they form a homogeneous and stable mixture and are compatible with the use envisaged. “Liquid fatty phase” refers to any nonaqueous medium which is liquid at room temperature. “Volatile fatty phase” refers to any nonaqueous medium capable of evaporating from the skin or the lips, at room temperature, in less than one hour.

Nonvolatile liquid lipophilic or fatty phase which can be used in the invention, include hydrocarbon oils such as paraffin oil or liquid petroleum jelly, vison oil, turtle oil, soya bean oil, perhydrosqualene, sweet almond oil, calophyllum oil, palm oil, grapeseed oil, sesame oil, maize oil, parleam oil, arara oil, rapeseed oil, sunflower oil, cottonseed oil, apricot oil, castor oil, avocado oil, jojoba oil, olive oil or cereal germ oil; esters of lanolic acid, oleic acid, lauric acid or stearic acid; fatty esters, such as isopropyl myristate, isopropyl palmitate, butyl stearate, hexyl laurate, diisopropyl adipate, isononyl isononate, 2-ethylhexyl palmitate, 2-hexyldecyl laurate, 2-octyldecyl palmitate, 2-octyldodecyl myristate or lactate, 2-diethylhexyl succinate, diisostearyl malate, glyceryl or diglyceryl triisostearate; higher fatty acids such as myristic acid, palmitic acid, stearic acid, behenic acid, oleic acid, linoleic acid, linolenic acid or isostearic acid; higher fatty alcohols such as cetanol, stearyl alcohol or oleyl alcohol, linoleyl or linolenyl alcohol, isostearyl alcohol or octyl dodecanol; silicone oils such as polydimethylsiloxane (PDMS), which are optionally phenylated, such as phenyl trimethicones, or which are optionally substituted with optionally fluorinated aliphatic and/or aromatic groups, or with functional groups such as hydroxyl, thiol and/or amine groups; polysiloxanes modified with fatty acids, fatty alcohols or polyoxyalkylenes, fluorinated silicones and perfluorinated oils.

One or more oils which are volatile at room temperature and atmospheric pressure may optionally be used. These volatile oils have for example a steam pressure at ambient temperature and pressure of, preferably, from 1×10⁻³ to 300 mm Hg, provided that the boiling point is greater than 25° C. These volatile oils facilitate in particular the application of the composition to the skin, the mucous membranes and the superficial body growths. These oils may be hydrocarbon oils, silicone oils optionally comprising alkyl or alkoxy groups at the end of the silicone or pendant chain.

The volatile silicone oil which may be used in the invention, is selected from the group consisting of D_{f}, M′D′ᵢM′ or TD′ [symbol] M′₃ where D_{f}, M′D′ᵢM′ and TD′ [symbol] M′₃ are as previously defined. The volatile oils represent preferably from 0 to 97.5% of the total weight of the composition, and more preferably from 5 to 85%. These ranges include all specific values and subranges therebetween, including 0.5, 1, 2, 8, 10, 15, 25, 30, 50, 60, 70, 80, 90 and 95% by weight.

Among the liquid lipophilic or fatty phases suitable for the compositions of the present invention are vegetable oils formed by esters of fatty acids and polyols, in particular triglycerides, such as sunflower, sesame or rapeseed oil, or the esters derived from long-chain acids or alcohols (that is to say having from 6 to 20 carbon atoms), in particular the esters of formula RCOOR′ in which R represents the residue of a higher fatty acid containing from 7 to 19 carbon atoms and R′ represents a hydrocarbon chain containing from 3 to 20 carbon atoms, such as palmitates, adipates and benzoates, in particular diisopropyl adipate. There may also be mentioned the hydrocarbons and in particular paraffin oils, liquid petroleum jelly, or hydrogenated polyisobutylene, isododecane, or alternatively the “ISOPARs”, volatile isoparaffins. There may also be mentioned the silicone oils such as polydimethylsiloxanes and polymethylphenylsiloxanes, optionally, substituted with optionally fluorinated aliphatic and/or aromatic groups, or with functional groups such as hydroxyl, thiol and/or amine groups, and the volatile, in particular cyclic, silicone oils. There may also be mentioned the solvents, alone or in the form of a mixture, chosen from (i) linear, branched or cyclic esters having more than 6 carbon atoms, (ii) ethers having more than 6 carbon atoms, (iii) ketones having more than 6 carbon atoms. Monoalcohols having an overall solubility parameter according to the HANSEN solubility space of less than or equal to 20 (MPa)^{1/2} are understood to mean the aliphatic fatty alcohols having at least 6 carbon atoms, the hydrocarbon chain containing no substitution group. As mono-alcohols according to the invention, there may be mentioned oleyl alcohol, decanol, dodecanol, octadecanol and linoleyl alcohol.

Preferably the dispersant is selected from the group consisting of hydrocarbon oils, paraffin oil, liquid petroleum jelly, vison oil, turtle oil, soya bean oil, perhydrosqualene, sweet almond oil, calophyllum oil, palm oil, grapeseed oil, sesame oil, maize oil, parleam oil, arara oil, rapeseed oil, sunflower oil, cottonseed oil, apricot oil, castor oil, avocado oil, jojoba oil, olive oil, cereal germ oil; esters of lanolic acid, esters of oleic acid, esters of lauric acid, esters of stearic acid; isopropyl myristate, isopropyl palmitate, butyl stearate, hexyl laurate, diisopropyl adipate, isononyl isononate, 2-ethylhexyl palmitate, 2-hexyldecyl laurate, 2-octyldecyl palmitate, 2-octyldodecyl myristate or lactate, 2-diethylhexyl succinate, diisostearyl malate, glyceryl triisostearate, diglyceryl triisostearate, myristic acid, palmitic acid, stearic acid, behenic acid, oleic acid, linoleic acid, linolenic acid, isostearic acid; cetanol, stearyl alcohol, oleyl alcohol, linoleyl or linolenyl alcohol, isostearyl alcohol or octyl dodecanol; silicone oils, polydimethylsiloxane, phenylated polydimethylsiloxane, polymethylphenylsiloxanes, phenyl trimethicones, phenyl trimethicones substituted with fluorinated aliphatic and/or aromatic groups, phenyl trimethicones substituted with functional groups such as hydroxyl, thiol and/or amine groups; polysiloxanes modified with fatty acids, fatty alcohols or polyoxyalkylenes; fluorinated silicones, perfluorinated oils, vegetable oils, sunflower oil, sesame oil, rapeseed oil, the esters long-chain acids or alcohols having the formula RCOOR′ in which R represents the residue of a higher fatty acid containing from 7 to 19 carbon atoms and R′ represents a hydrocarbon chain containing from 3 to 20 carbon atoms, hydrogenated polyisobutylene, isododecane, volatile isoparaffins, oleyl alcohol, decanol, dodecanol, octadecanol and linoleyl alcohol.

The choice of the non-aqueous medium is made by persons skilled in the art as a function of the nature of the monomers constituting the polymer and/or of the nature of the stabilizer, as indicated below. In particular, it is possible to use a polar or weakly polar oils such as vegetable oils of the long carbon chain-containing triglyceride type (apricot oil, jojoba oil) or the long carbon chain-containing esters such as octyldodecyl neopentanoate, the alkanes such as parleam oil, and the silicone oils. Furthermore, the total liquid lipophilic or fatty phase in which the polymer is dispersed may represent from 30% to 98% of the total weight of the composition and preferably from 30 to 75%. These ranges for the total liquid lipophilic or fatty phase include all specific values and sub-ranges therebetween, including 35, 40, 45, 50, 60, 70, 80, 85, 90 and 95% of the total weight of the composition. The nonvolatile part represents at least 0.5% and in practice from 1 to 30% of the total weight of the composition. These ranges for the nonvolatile part include all specific values and subranges therebetween, including 2, 3, 5, 10, 15, 20 and 25% of the total weight of the composition.

The personal care applications where the compositions of the present invention may be employed include, but are not limited to, deodorants, antiperspirants, antiperspirant/deodorants, shaving products, skin lotions, moisturizers, toners, bath products, cleansing products, hair care products such as shampoos, conditioners, mousses, styling gels, hair sprays, hair dyes, hair color products, hair bleaches, waving products, hair straighteners, manicure products such as nail polish, nail polish remover, nails creams and lotions, cuticle softeners, protective creams such as sunscreen, insect repellent and anti-aging products, color cosmetics such as lipsticks, foundations, face powders, eye liners, eye shadows, blushes, makeup, mascaras and other personal care formulations where silicone components have been conventionally added, as well as drug delivery systems for topical application of medicinal compositions that are to be applied to the skin.

In a preferred embodiment, the personal care composition of the present invention further comprises one or more personal care ingredients. Suitable personal care ingredients or active ingredients include, for example, emollients, moisturizers, humectants, pigments, including pearlescent pigments such as, for example, bismuth oxychloride and titanium dioxide coated mica, colorants, fragrances, biocides, preservatives, antioxidants, anti-microbial agents, anti-fungal agents, antiperspirant agents, exfoliants, hormones, enzymes, medicinal compounds, vitamins, salts, electrolytes, alcohols, polyols, absorbing agents for ultraviolet radiation, botanical extracts, surfactants,-silicone oils, solid or liquid silicone resins, silicone quats, organic oils, waxes, film formers, thickening agents such as, for example, fumed silica or hydrated silica, particulate fillers, such as for example, talc, kaolin, starch, modified starch, mica, nylon, polymethylsilsequioxane, clays, such as, for example, bentonite and organo-modified clays.

Suitable personal care compositions are made by combining, in a manner known in the art, such as, for example, by mixing, one or more of the above components with the siloxane copolymer network or precursors thereto, preferably in the form of the silicone compositions of the present invention. Thus the entrapped, occluded or encapsulated materials may be incorporated into the silicone network at any point in the preparation of the cosmetic compositions of the present invention provided they do not interfere with the preparation of the silicone gel or siloxane copolymer network. Suitable personal care compositions may be in the form of a single phase or in the form of an emulsion, including but not limited to oil-in-water, water-in-oil and anhydrous emulsions where the silicone phase may be either the discontinuous phase or the continuous phase, as well as multiple emulsions, such as, for example, oil-in water-in-oil emulsions and water-in-oil-in water-emulsions.

The compositions of the present invention may be utilized as prepared or as one or more components in emulsions. As is generally known, emulsions comprise at least two immiscible phases one of which is continuous and the other which is discontinuous. Further emulsions may be liquids with varying viscosities comprising solids. Additionally the particle size of the emulsions may render them microemulsions and when sufficiently small such microemulsions may be transparent. Further it is also possible to prepare emulsions of emulsions and these are generally known as multiple emulsions.

These primary types of emulsions may be:

1) aqueous emulsions where the continuous phase comprises water and the discontinuous phase comprises the polyether siloxane copolymer network of the present invention;

2) aqueous emulsions where the continuous phase comprises the polyether siloxane copolymer network of the present invention and the discontinuous phase comprises water;

3) non-aqueous emulsions where the discontinuous phase comprises a non-aqueous hydroxylic solvent and the continuous phase comprises the polyether siloxane copolymer network of the present invention; and

4) non-aqueous emulsions where the continuous phase comprises a non-aqueous hydroxylic organic solvent and the discontinuous phase comprises the polyether siloxane copolymer network of the present invention.

Non-aqueous emulsions comprising a silicone phase are described in U.S. Pat. Nos. 6,060,546 and 6,271,295 the disclosures of which are herewith and hereby specifically incorporated by reference.

As used herein the term “non-aqueous hydroxylic organic compound” means hydroxyl containing organic compounds as exemplified by but not limited to alcohols, glycols, polyhydric alcohols and polymeric glycols and mixtures thereof that are liquid at room temperature, e.g. about 25° C., and about one atmosphere pressure. The non-aqueous organic hydroxylic solvents are selected from the group consisting of hydroxyl containing organic compounds comprising alcohols, glycols, polyhydric alcohols and polymeric glycols and mixtures thereof that are liquid at room temperature, e.g. about 25° C., and about one atmosphere pressure. Preferably the non-aqueous hydroxylic organic solvent is selected from the group consisting of ethylene glycol, ethanol, propyl alcohol, iso-propyl alcohol, propylene glycol, dipropylene glycol, tripropylene glycol, butylene glycol, iso-butylene glycol, methyl propane diol, glycerin, sorbitol, polyethylene glycol, polypropylene glycol mono alkyl ethers, polyoxyalkylene copolymers and mixtures thereof.

Once the desired form is attained whether as a silicone only phase, an anhydrous mixture comprising the silicone phase (that may or may not contain so-called non-intended water), a hydrous mixture comprising the silicone phase, a water-in-oil emulsion, an oil-in-water emulsion, or either of the two non-aqueous emulsions or variations thereon, the resulting material is usually a high viscosity cream with good feel characteristics, and high absorbance of volatile solvent. It is capable of being blended into formulations for hair care, skin care, antiperspirants, sunscreens, cosmetics, color cosmetics, insect repellants, vitamin and hormone carriers, fragrance carriers and the like.

Colored materials suitable for use in the compositions of the present invention vary according to the laws of the country where the compositions are being sold because they involve topical application to human beings. However, even though categorized by the suitability for use in the United States (US) or in the European Union (EU) the term colored materials includes all the colored materials in the following lists, lists A through D inclusive and all possible sub-combinations thereof:

List A. Certified Organic Colors Listed for Cosmetic Uses in the U.S. and EU:

FD&C blue no. 1, FD&C green no. 3, FD&C red no. 4, FD&C red no. 40, FD&C yellow no. 5, FD&C yellow no. 6, D&C blue no. 4, D&C brown no. 1, D&C green no. 5, D&C green no. 6, D&C green no. 8, D&C orange no. 4, D&C orange no. 5, D&C orange no. 10, D&C orange no. 11, D&C red no. 6, D&C red no. 7, D&C red no. 17, D&C red no. 21, D&C red no. 22, D&C red no. 27, D&C red no. 28, D&C red no. 30, D&C red no. 31, D&C red no. 33, D&C red no. 34, D&C red no. 36, D&C violet no. 2, D&C yellow no. 7, D&C yellow no. 8, D&C yellow no. 10, D&C yellow no. 11, Ext. D&C violet no. 2, and Ext. D&C yellow no. 7.

List B. Inorganic Colors Listed for Cosmetic Uses in the U.S. and EU:

Iron oxide (red, yellow, black), Titanium dioxide, Zinc oxide, Ultramarine, Bismuth oxychloride, Chromium oxide green, Chromium hydroxide green, Ferric ferrocyanide, Manganese violet, and Guanine

List C. Additional only EU-Approved Colors List for Cosmetic Uses:

Acid green no. 1, Pigment yellow no. 1, Pigment yellow no. 3, Solvent red no. 3, Solvent red no. 1, Pigment red no. 112, Pigment red no. 5, Acid orange no. 6, Acid red no. 14, Pigment red no. 68, Pigment red no. 48, Acid red no. 27 & Al lake, Acid red no. 18, Acid black no. 1, Pigment yellow no. 13, Solvent yellow no. 29, Acid red no. 73, Brilliant black no. 1, Acid blue no. 1, Acid blue no. 3, Basic violet no. 14, Basic blue no. 26, Acid green no. 50, Acid red no. 52, Acid violet no. 9, Acid red no. 51, Pigment violet no. 23, Pigment red no. 83, Acid blue no. 62, Acid blue no. 74, Pigment violet no. 19, Pigment blue no. 15, Direct blue no. 86, Pigment green no. 7, Bentonite, Barium sulfate, Calcium sulfate, Carbon black, Iron oxide (orange), Magnesium carbonate, Lactoflavin, Capsanthin, capsorubin, Beetroot red, Anthocyanins, Aluminum stearate, Zinc stearate, Magnesium stearate, Calcium stearate, Bromothymol blue, Bromocresol green, Acid red, Color Index (CI) 195, CI 18736, CI 18820, CI 18965, CI 20040, CI 21108, CI 24790, CI 27755, CI 40215, CI 40820, CI 40825, CI 40850, Cl 42080, CI 42090, CI 42100, CI 42170, CI 42520, CI 42735, CI 45220, CI 45396, CI 45405, CI 50325, CI 50420, CI 60724, CI 61585, CI 69800, CI 69825, CI 71105, CI 73000, CI 73385, CI 73915, CI 74100, CI 75100, CI 75125, CI 75135, CI 75300, CI 77002, CI 77015, CI 77220, CI 77267, CI 77268:1, CI 77346, CI 77480, and CI 77745

List D. Other Colors List for Cosmetic Uses:

Beta carotene, Annatto, Caramel, Carmine, Chlorophyllin-copper complex, Henna, Aluminum powder, Bronze or copper powder, Silver, Mica, and Titanated mica.

Experimental

Silicone Gels Comprising Encapsulated Pigments

### EXAMPLE 1

(Silicone Gel II):

To a mixture of b 303.3 g of titanium oxide, 72.8 g of yellow iron oxide, 18.8 g of red iron oxide and 5.2 g of black iron oxide was added 200 g of organopolysiloxane with the average structure HMe₂SiO(Me₂SiO)₃₈₈(MeHSiO)_{6.9}SiMe₂H, and mixed in a high shear mixer for 1 h and then roll-milled to prepare a smooth masterbatch paste.

204 g of this masterbatch paste, 200 g of HMe₂SiO(Me₂SiO)₃₈₈(MeHSiO)_{6.9}SiMe₂H, 4.47 g of vinyl cyclohexene oxide, 22.38 g of organopolysiloxane with the average structure CH₂═CH—(CH₂)₂₇—CH₃, 560 g of decamethylcyclopentasiloxane and 0.089 g of Karstedt catalyst (i.e., 10 weight % platinum in divinyltetramethyldisiloxane) were mixed. This solution was mixed at 100° C. for 1 hour. Then 4.47 g of an organopolysiloxane with average structure Me₃SiO(MeHSiO)₅₀SiMe₃ was added and the contents of the mixer was allowed to mix for a further 5 hours time at 100° C. to yield a powdered dry gel.

To 600 g of this powdered dry gel was added 955 g of decamethylcyclopentasiloxane, and allowed to swell overnight. The gel was processed by passing through a Gaulin homogenizer at 9000 psi pressure to yield a cream that had a viscosity of 184, 500 cstks.

In order to prove that the pigments were encased by the silicone gel, the following experiment was conducted. To 1.6 g of the powdered gel was added 10 g of n-heptane, and shaken for 45 minutes in small vial. The vial was then centrifuged to yield only two layers, the clear heptane layer and the pigment entrapped gel layer. A third layer containing the higher density unencased pigment was not observed.

### EXAMPLE 2

(Silicone Gel II):

To a mixture of 336.7 g of titanium oxide, 39.70 g of yellow iron oxide, 15.3 g of red iron oxide and 4.2 g of black iron oxide was added 199 g of organopolysiloxane with the average structure HMe₂SiO(Me₂SiO)₁₃₃(MeHSiO)_{2.5}SiMe₂H, and mixed in a high shear mixer for 1 h and then roll-milled to prepare a smooth masterbatch paste.

346.7 g of this masterbatch paste, 144.9 g of organopolysiloxane with the average structure HMe₂SiO(Me₂SiO)₁₃₃(MeHSiO)_{2.5}SiMe₂H, 8.53 g of vinyl cyclohexene oxide, 21.5 g of CH₂═CH—(CH₂)₂₇—CH₃, 450 g of decamethylcyclopentasiloxane and 0.1 g of Karstedt's catalyst (as previously described) were mixed. This solution was mixed at 100° C. for 1 hour. Then 15 g of organopolysiloxane with the average structure Me₃SiO(MeHSiO)₅₀SiMe₃ was added and the contents of the mixer was allowed to mix for a further 5 hours time at 100° C. Then 13 g of CH₂═CH—(CH₂)₁₄—CH₃ quencher was added and the reaction heated and mixed for additional 30 minutes to yield a powdered dry gel

To 800 g of this powdered gel was added 1063 g of decamethylcyclopentasiloxane, and allowed to swell overnight. The gel was processed by passing through a Gaulin homogenizer at 9000 psi pressure to yield a cream that had a viscosity of 202,000 cstks.

In order to prove that the pigments were encased by the silicone gel, the following experiment was conducted again. To 1.6 g of the powdered gel was added 10 g of n-heptane and shaken for 45 minutes in small vial. The vial was then centrifuged to yield only two layers, the clear heptane layer and the pigment entrapped gel layer. A third layer containing the higher density unencased pigments was not observed.

### EXAMPLE 3

(Silicone Gel VI):

300 g of organopolysiloxane with the average structure Me₃SiO(Me₂SiO)₁₀₀(MeHSiO)_{6.65}SiMe₃ and 18.51 g CH₂═CHCH₂O(CH₂CH₂O)₈H were mixed in 300 g of isopropanol in three neck round bottom flask. 0.06 g of Karstedt's catalyst solution was added to this mixture and heated to maintain a temperature of 70° C. After 2 h, the three-neck flask was connected to a vacuum pump and evacuated to remove isopropanol. A polyether branched organosiloxane polymer was obtained in quantitative yield.

To a mixture of 255 g of titanium oxide, 24 g of yellow iron oxide, 15 g of red iron oxide and 6 g of black iron oxide was added 150 g of the above polyether branched organosiloxane polymer, and mixed in a high shear mixer for 1 h and then roll-milled to prepare a smooth masterbatch paste. 104 g of this masterbatch paste, 100 g of the above polyether branched organosiloxane polymer, 3.7 g of 1,5-hexadiene, 485 g of decamethylcyclopentasiloxane and 0.069 g of Karstedt's catalyst (as previously described) were mixed at room temperature for 1 h to yield a powdered silicone gel. The contents of the mixer were then allowed to mix for a further 2 hours time at 100° C. The batch was then cooled to yield powdered silicone gel.

To 650 g of this powdered gel was added 550 g of decamethylcyclopentasiloxane, and allowed to swell overnight. The gel was processed by passing through a Gaulin homogenizer at 8000 psi pressure to yield a cream that had a viscosity of 321,000 cstks.

Once again the pigments were found to be encased by the silicone gel using a methodology as described in example 2.

### EXAMPLE 4

(Silicone Gel VI):

To a mixture of 859.2 g of titanium oxide, 82.4 g of yellow iron oxide, 42.5 g of red iron oxide and 15 g of black iron oxide was added 429.3 g of organopolysiloxane with the average structure Me₃SiO(Me₂SiO)₂₀(MeHSiO)₃SiMe₃, and mixed in a high shear mixer for 1 h and then roll-milled to prepare a smooth masterbatch paste.

143 g of this masterbatch paste, 125 g of organopolysiloxane with the average structure Me₃SiO(Me₂SiO)₂₀(MeHSiO)₃SiMe₃, 11.7 of 1,5-hexadiene, 720 g of decamethylcyclopentasiloxane and 0.1 g of Karstedt's catalyst (as previously described) were mixed at room temperature. Gelation occurred within 1.5 hours. The reaction was mixed in then for 8 h at room temperature to yield a powdered silicone gel.

To 700 g of this powdered gel was added 500 g of decamethylcyclopentasiloxane, and allowed to swell overnight. The gel was processed by passing through a Gaulin homogenizer at 8000 psi pressure to yield a cream that had a viscosity of 100,000 cstks.

Once again, the pigments were found to be encased by the silicone gel using a methodology as described in example 2.

### EXAMPLE 5

(Silicone Gel IV):

143 g of the masterbatch paste from example 4, 36 g of organopolysiloxane with the average structure Me₃SiO(Me₂SiO)₂₀(MeHSiO)₃SiMe₃, 122 g of organopolysiloxane with the average structure CH2═CH—Me₂SiO(Me₂SiO)₂₀SiMe₂—CH═CH₂, 600 g of decamethylcyclopentasiloxane were mixed at room temperature for 1 hour. Then 0.1 g of Karstedt's catalyst (as previously described) in 100 g of decamethylcyclopentasiloxane was added to the mixer. Gelation occurred within 30 minutes at room temperature. The reaction was then heated and maintained at 100° C. for 2 h. The reaction was then cooled down to room temperature to yield a powdered silicone gel.

To 700 g of this powdered gel was added 500 g of decamethylcyclopentasiloxane, and allowed to swell overnight. The gel was processed by passing through a Gaulin homogenizer at 8000 psi pressure to yield a cream that had a viscosity of 71, 250 cstks.

Once again, the pigments were found to be encased by the silicone gel using a methodology as described in example 2.

### EXAMPLE 6

(Silicone Gel I):

To a mixture of 264 g of titanium oxide, 21 g of yellow iron oxide, 10.5 g of red iron oxide and 4.5 g of black iron oxide was added 150 g of organopolysiloxane with the average structure CH2═CH—Me₂SiO(Me₂SiO)₈₀₀SiMe₂—CH═CH₂, and mixed in a high shear mixer for 1 h and then roll-milled to prepare a smooth masterbatch paste.

300 g of this masterbatch paste, 150 g of organopolysiloxane with the average structure CH2═CH—Me₂SiO(Me₂SiO)₈₀₀SiMe₂—CH═CH₂, 1.2 of (M^{H}₂Q)_{4,} 450 g of decamethylcyclopentasiloxane were mixed in a dough mixer at room

Having described the invention that which is claimed is:

1. A method for making a pigmented cosmetic composition comprising:
(a) preparing a silicone gel comprising an entrapped, occluded or encapsulated pigment; and
(b) dispersing said gel in a dispersant medium.

2. The method of claim 1 wherein the silicone gel is selected from the group of gels consisting of:
(i) a gel formed from a silicone and a hydrosilylation compatible solvent wherein said silicone is prepared by the hydrosilylation of a linear alkenyl polyorganosiloxane and a hydride resin;
(ii) a gel formed as a reaction product of an epoxy functional hydrido-siloxane said reaction product being formed in an epoxy-gel formation compatible solvent;
(iii) a gel formed from a silicone and a hydrosilylation compatible solvent wherein said silicone is prepared by the hydrosilylation of a linear hydrogen polyorganosiloxane and an alkenyl resin;
(iv) a gel formed from a silicone and a hydrosilylation compatible solvent wherein said silicone is prepared by the hydrosilylation of a linear hydrogen polyorganosiloxane and a linear alkenyl polyorganosiloxane;
(v) a gel formed from a silicone and hydrosilylation compatible solvent wherein said silicone is prepared by the hydrosilylation of a hydrogen polyorganosiloxane resin and an alkenyl polyorganosiloxane resin;
(vi) a gel formed from a silicone and a hydrosilylation compatible solvent wherein said silicone is prepared by the hydrosilylation of a linear hydrogen organopoly-siloxane having two or more hydride functionalities per molecule and an α,ω reactive organic molecule possessing two or more reactive functionalities per molecule; and
(vii) a gel formed as a reaction product of a vinyl functional hydrido-siloxane in a hydrosilylation compatible solvent.

3. The method of claim 1 wherein the dispersant medium is selected from the group consisting of physiologically acceptable liquid lipophilic or fatty phases and silicone fluids.

4. The method of claim 3 wherein the silicone gel is selected from the group of gels consisting of:
(i) a gel formed from a silicone and a hydrosilylation compatible solvent wherein said silicone is prepared by the hydrosilylation of a linear alkenyl polyorganosiloxane and a hydride resin;
(ii) a gel formed as a reaction product of an epoxy functional hydrido-siloxane said reaction product being formed in an epoxy-gel formation compatible solvent;
(iii) a gel formed from a silicone and a hydrosilylation compatible solvent wherein said silicone is prepared by the hydrosilylation of a linear hydrogen polyorganosiloxane and an alkenyl resin;
(iv) a gel formed from a silicone and a hydrosilylation compatible solvent wherein said silicone is prepared by the hydrosilylation of a linear hydrogen polyorganosiloxane and a linear alkenyl polyorganosiloxane;
(v) a gel formed from a silicone and hydrosilylation compatible solvent wherein said silicone is prepared by the hydrosilylation of a hydrogen polyorganosiloxane resin and an alkenyl polyorganosiloxane resin;
(vi) a gel formed from a silicone and a hydrosilylation compatible solvent wherein said silicone is prepared by the hydrosilylation of a linear hydrogen organopolysiloxane having two or more hydride functionalities per molecule and an α,ω reactive organic molecule possessing two or more reactive functionalities per molecule; and
(vii) a gel formed as a reaction product of a vinyl functional hydrido-siloxane in a hydrosilylation compatible solvent.

5. The method of claim 1 wherein the cosmetic is selected from the group consisting of lipsticks, foundations, face powders, eye liners, eye shadows, blushes, makeup, and mascara.

6. The method of claim 2 wherein the cosmetic is selected from the group consisting of lipsticks, foundations, face powders, eye liners, eye shadows, blushes, makeup, and mascara.

7. The method of claim 3 wherein the cosmetic is selected from the group consisting of lipsticks, foundations, face powders, eye liners, eye shadows, blushes, makeup, and mascara.

8. The method of claim 4 wherein the cosmetic is selected from the group consisting of lipsticks, foundations, face powders, eye liners, eye shadows, blushes, makeup, and mascara.

9. A method for preparing a pigmented cosmetic composition comprising:
(a) preparing a silicone gel comprising an entrapped or encapsulated pigment selected from the group of silicone gels consisting of:
(i) a gel formed from a silicone and a hydrosilylation compatible solvent wherein said silicone is prepared by the hydrosilylation of a linear alkenyl polyorganosiloxane and a hydride resin;
(ii) a gel formed as a reaction product of an epoxy functional hydrido-siloxane said reaction product being formed in an epoxy-gel formation compatible solvent;
(iii) a gel formed from a silicone and a hydrosilylation compatible solvent wherein said silicone is prepared by the hydrosilylation of a linear hydrogen polyorganosiloxane and an alkenyl resin;
(iv) a gel formed from a silicone and a hydrosilylation compatible solvent wherein said silicone is prepared by the hydrosilylation of a linear hydrogen polyorganosiloxane and a linear alkenyl polyorganosiloxane;
(v) a gel formed from a silicone and hydrosilylation compatible solvent wherein said silicone is prepared by the hydrosilylation of a hydrogen polyorganosiloxane resin and an alkenyl polyorganosiloxane resin;
(vi) a gel formed from a silicone and a hydrosilylation compatible solvent wherein said silicone is prepared by the hydrosilylation of a linear hydrogen organopolysiloxane having two or more hydride functionalities per molecule and an UX, co reactive organic molecule possessing two or more reactive functionalities per molecule; and
(vii) a gel formed as a reaction product of a vinyl functional hydrido-siloxane in a hydrosilylation compatible solvent;
wherein said pigment is selected from the group consisting of FD&C blue no. 1, FD&C green no. 3, FD&C red no. 4, FD&C red no. 40, FD&C yellow no. 5, FF&C yellow no. 6, D&C blue no. 4, D&C brown no. 1, D&C green no. 5, D&C green no. 6, D&C green no. 8, D&C orange no. 4, D&C orange no. 5, D&C orange no. 10, D&C orange no. 11, D&C red no. 6, D&C red no. 7, D&C red no. 17, D&C red no. 21, D&C red no. 22, D&C red no. 27, D&C red no. 28, D&C red no. 30, D&C red no. 31, D&C red no. 33, D&C red no. 34, D&C red no. 36, D&C violet no. 2, D&C yellow no. 7, D&C yellow no. 8, D&C yellow no. 10, D&C yellow no. 11, Ext. D&C violet no. 2, Ext. D&C yellow no. 7, Iron oxide (red, yellow, black), Titanium dioxide, Zinc oxide, Ultramarine, Bismuth oxychloride, Chromium oxide green, Chromium hydroxide green, Ferric ferrocyanide, Manganese violet, Guanine, Acid green no. 1, Pigment yellow no. 1 , Pigment yellow no. 3, Solvent red no. 3, Solvent red no. 1, Pigment red no. 112, Pigment red no. 5, Acid orange no. 6, Acid red no. 14, Pigment red no. 68, Pigment red no. 48, Acid red no. 27 & Al lake, Acid red no. 18, Acid black no. 1, Pigment yellow no. 13, Solvent yellow no. 29, Acid red no. 73, Brilliant black no. 1, Acid blue no. 1, Acid blue no. 3, Basic violet no. 14, Basic blue no. 26, Acid green no. 50, Acid red no. 52, Acid violet no. 9, Acid red no. 51, Pigment violet no. 23, Pigment red no. 83, Acid blue no. 62, Acid blue no. 74, Pigment violet no. 19, Pigment blue no. 15, Direct blue no. 86, Pigment green no. 7, Bentonite, Barium sulfate, Calcium sulfate, Carbon black, Iron oxide (orange), Magnesium carbonate, Lactoflavin, Capsanthin, capsorubin, Beetroot red, Anthocyanins, Aluminum stearate, Zinc stearate, Magnesium stearate, Calcium stearate, Bromothymol blue, Bromocresol green, Acid red, Color Index (CI) 195, CI 18736, CI 18820, CI 18965, CI 20040, CI 21108, CI 24790, CI 27755, CI 40215, CI 40820, CI 40825, CI 40850, CI 42080, CI 42090, CI 42100, CI 42170, CI 42520, CI 42735, CI 45220, CI 45396, CI 45405, CI 50325, CI 50420, CI 60724, CI 61585, CI 69800, CI 69825, CI 71105, CI 73000, CI 73385, CI 73915, CI 74100, CI 75100, CI 75125, CI 75135, CI 75300, CI 77002, CI 77015, CI 77220, CI 77267, CI 77268:1, CI 77346, CI 77480, CI 77745, Beta carotene, Annatto, Caramel, Carmine, Chlorophyllin-copper complex, Henna; and
(c) dispersing the silicone gel in a dispersant medium selected from the group consisting of hydrocarbon oils, paraffin oil, liquid petroleum jelly, vison oil, turtle oil, soya bean oil, perhydrosqualene, sweet almond oil, calophyllum oil, palm oil, grapeseed oil, sesame oil, maize oil, parleam oil, arara oil, rapeseed oil, sunflower oil, cottonseed oil, apricot oil, castor oil, avocado oil, jojoba oil, olive oil, cereal germ oil; esters of lanolic acid, esters of oleic acid, esters of lauric acid, esters of stearic acid; isopropyl myristate, isopropyl palmitate, butyl stearate, hexyl laurate, diisopropyl adipate, isononyl isononate, 2-ethylhexyl palmitate, 2-hexyldecyl laurate, 2-octyldecyl palmitate, 2-octyldodecyl myristate or lactate, 2-diethylhexyl succinate, diisostearyl malate, glyceryl triisostearate, diglyceryl triisostearate, myristic acid, palmitic acid, stearic acid, behenic acid, oleic acid, linoleic acid, linolenic acid, isostearic acid; cetanol, stearyl alcohol, oleyl alcohol, linoleyl or linolenyl alcohol, isostearyl alcohol or octyl dodecanol; silicone oils, polydimethylsiloxane, phenylated polydimethylsiloxane, polymethylphenylsiloxanes, phenyl trimethicones, phenyl trimethicones substituted with fluorinated aliphatic and/or aromatic groups, phenyl trimethicones substituted with functional groups such as hydroxyl, thiol and/or amine groups; polysiloxanes modified with fatty acids, fatty alcohols or polyoxyalkylenes; fluorinated silicones, perfluorinated oils, vegetable oils, sunflower oil, sesame oil, rapeseed oil, the esters long-chain acids or alcohols having the formula RCOOR′ in which R represents the residue of a higher fatty acid containing from 7 to 19 carbon atoms and R′ represents a hydrocarbon chain containing from 3 to 20 carbon atoms, hydrogenated polyisobutylene, isododecane, volatile isoparaffins, oleyl alcohol, decanol, dodecanol, octadecanol and linoleyl alcohol.

10. The method of claim 9 wherein the cosmetic is selected from the group consisting of lipsticks, foundations, face powders, eye liners, eye shadows, blushes, makeup, and mascara;

11. The method of claim 10 wherein the silicone gel is a gel formed from a silicone and a hydrosilylation compatible solvent wherein said silicone is prepared by the hydrosilylation of a linear alkenyl polyorganosiloxane and a hydride resin.

12. The method of claim 10 wherein the silicone gel is a gel formed as a reaction product of an epoxy functional hydrido-siloxane said reaction product being formed in an epoxy-gel formation compatible solvent.

13. The method of claim 10 wherein the silicone gel is a gel formed from a silicone and a hydrosilylation compatible solvent wherein said silicone is prepared by the hydrosilylation of a linear hydrogen polyorganosiloxane and an alkenyl resin.

14. The method of claim 10 wherein the silicone gel is a gel formed from a silicone and a hydrosilylation compatible solvent wherein said silicone is prepared by the hydrosilylation of a linear hydrogen polyorganosiloxane and a linear alkenyl polyorganosiloxane.

15. The method of claim 10 wherein the silicone gel is a gel formed from a silicone and hydrosilylation compatible solvent wherein said silicone is prepared by the hydrosilylation of a hydrogen polyorganosiloxane resin and an alkenyl polyorganosiloxane resin.

16. The method of claim 10 wherein the silicone gel is a gel formed from a silicone and a hydrosilylation compatible solvent wherein said silicone is prepared by the hydrosilylation of a linear hydrogen organopolysiloxane having two or more hydride functionalities per molecule and an α,ω reactive organic molecule possessing two or more reactive functionalities per molecule.

17. The method of claim 10 wherein the silicone gel is a gel formed as a reaction product of a vinyl functional hydrido-siloxane in a hydrosilylation compatible solvent.

18. A method for making a cosmetic composition consisting essentially of:
(a) preparing a silicone gel comprising an entrapped or encapsulated pigment; and
(b) dispersing the silicone gel in a dispersant medium; and
(c) homogenizing said silicone gel in said dispersant medium..

19. A method for making a cosmetic composition consisting of:
(a) preparing a silicone gel comprising an entrapped or encapsulated pigment; and
(b) dispersing the silicone gel in a dispersant medium: and
(c) homogenizing said silicone gel in said dispersant medium.

20. A method for making a pigmented cosmetic composition comprising:
(a) preparing a silicone gel comprising an entrapped, occluded or encapsulated pigment;
(b) dispersing said gel in a dispersant medium; and
(c) homogenizing said silicone gel in said dispersant medium.

21. The method of claim 20 wherein the silicone gel is selected from the group of gels consisting of:
(i) a gel formed from a silicone and a hydrosilylation compatible solvent wherein said silicone is prepared by the hydrosilylation of a linear alkenyl polyorganosiloxane and a hydride resin;
(ii) a gel A formed as a reaction product of an epoxy functional hydrido-siloxane said reaction product being formed in an epoxy-gel formation compatible solvent;
(iii) a gel formed from a silicone and a hydrosilylation compatible solvent wherein said silicone is prepared by the hydrosilylation of a linear hydrogen polyorganosiloxane and an alkenyl resin;
(iv) a gel formed from a silicone and a hydrosilylation compatible solvent wherein said silicone is prepared by the hydrosilylation of a linear hydrogen polyorganosiloxane and a linear alkenyl polyorganosiloxane;
(v) a gel formed from a silicone and hydrosilylation compatible solvent wherein said silicone is prepared by the hydrosilylation of a hydrogen polyorganosiloxane resin and an alkenyl polyorganosiloxane resin;
(vi) a gel formed from a silicone and a hydrosilylation compatible solvent wherein said silicone is prepared by the hydrosilylation of a linear hydrogen organopoly-siloxane having two or more hydride functionalities per molecule and an α,ω reactive organic molecule possessing two or more reactive functionalities per molecule; and
(vii) a gel formed as a reaction product of a vinyl functional hydrido-siloxane in a hydrosilylation compatible solvent.

22. The method of claim 20 wherein the dispersant medium is selected from the group consisting of physiologically acceptable liquid lipophilic or fatty phases and silicone fluids.

23. The method of claim 22 wherein the silicone gel is selected from the group of gels consisting of:
(i) a gel formed from a silicone and a hydrosilylation compatible solvent wherein said silicone is prepared by the hydrosilylation of a linear alkenyl polyorganosiloxane and a hydride resin;
(ii) a gel formed as a reaction product of an epoxy functional hydrido-siloxane said reaction product being formed in an epoxy-gel formation compatible solvent;
(iii) a gel formed from a silicone and a hydrosilylation compatible solvent wherein said silicone is prepared by the hydrosilylation of a linear hydrogen polyorganosiloxane and an alkenyl resin;
(iv) a gel formed from a silicone and a hydrosilylation compatible solvent wherein said silicone is prepared by the hydrosilylation of a linear hydrogen polyorganosiloxane and a linear alkenyl polyorganosiloxane;
(v) a gel formed from a silicone and hydrosilylation compatible solvent wherein said silicone is prepared by the hydrosilylation of a hydrogen polyorganosiloxane resin and an alkenyl polyorganosiloxane resin;
(vi) a gel formed from a silicone and a hydrosilylation compatible solvent wherein said silicone is prepared by the hydrosilylation of a linear hydrogen organopolysiloxane having two or more hydride functionalities per molecule and an α,ω reactive organic molecule possessing two or more reactive functionalities per molecule; and
(vii) a gel formed as a reaction product of a vinyl functional hydrido-siloxane in a hydrosilylation compatible solvent.

24. The method of claim 20 wherein the cosmetic is selected from the group consisting of lipsticks, foundations, face powders, eye liners, eye shadows, blushes, makeup, and mascara.

25. The method of claim 21 wherein the cosmetic is selected from the group consisting of lipsticks, foundations, face powders, eye liners, eye shadows, blushes, makeup, and mascara.

26. The method of claim 22 wherein the cosmetic is selected from the group consisting of lipsticks, foundations, face powders, eye liners, eye shadows, blushes, makeup, and mascara.

27. The method of claim 23 wherein the cosmetic is selected from the group consisting of lipsticks, foundations, face powders, eye liners, eye shadows, blushes, makeup, and mascara.

28. A method for preparing a pigmented cosmetic composition comprising:
(a) preparing a silicone gel comprising an entrapped or encapsulated pigment selected from the group of silicone gels consisting of:
(i) a gel formed from a silicone and a hydrosilylation compatible solvent wherein said silicone is prepared by the hydrosilylation of a linear alkenyl polyorganosiloxane and a hydride resin;
(ii) a gel formed as a reaction product of an epoxy functional hydrido-siloxane said reaction product being formed in an epoxy-gel formation compatible solvent;
(iii) a gel formed from a silicone and a hydrosilylation compatible solvent wherein said silicone is prepared by the hydrosilylation of a linear hydrogen polyorganosiloxane and an alkenyl resin;
(iv) a gel formed from a silicone and a hydrosilylation compatible solvent wherein said silicone is prepared by the hydrosilylation of a linear hydrogen polyorganosiloxane and a linear alkenyl polyorganosiloxane;
(v) a gel formed from a silicone and hydrosilylation compatible solvent wherein said silicone is prepared by the hydrosilylation of a hydrogen polyorganosiloxane resin and an alkenyl polyorganosiloxane resin;
(vi) a gel formed from a silicone and a hydrosilylation compatible solvent wherein said silicone is prepared by the hydrosilylation of a linear hydrogen organopolysiloxane having two or more hydride functionalities per molecule and an α,ω reactive organic molecule possessing two or more reactive functionalities per molecule; and
(vii) a gel formed as a reaction product of a vinyl functional hydrido-siloxane in a hydrosilylation compatible solvent;
wherein said pigment is selected from the group consisting of FD&C blue no. 1, FD&C green no. 3, FD&C red no. 4, FD&C red no. 40, FD&C yellow no. 5, FF&C yellow no. 6, D&C blue no. 4, D&C brown no. 1, D&C green no. 5, D&C green no. 6, D&C green no. 8, D&C orange no. 4, D&C orange no. 5, D&C orange no. 10, D&C orange no. 11, D&C red no. 6, D&C red no. 7, D&C red no. 17, D&C red no. 21, D&C red no. 22, D&C red no. 27, D&C red no. 28, D&C red no. 30, D&C red no. 31, D&C red no. 33, D&C red no. 34, D&C red no. 36, D&C violet no. 2, D&C yellow no. 7, D&C yellow no. 8, D&C yellow no. 10, D&C yellow no. 11, Ext. D&C violet no. 2, Ext. D&C yellow no. 7, Iron oxide (red, yellow, black), Titanium dioxide, Zinc oxide, Ultramarine, Bismuth oxychloride, Chromium oxide green, Chromium hydroxide green, Ferric ferrocyanide, Manganese violet, Guanine, Acid green no. 1, Pigment yellow no. 1, Pigment yellow no. 3, Solvent red no. 3, Solvent red no. 1, Pigment red no. 112, Pigment red no. 5, Acid orange no. 6, Acid red no. 14, Pigment red no. 68, Pigment red no. 48, Acid red no. 27 & Al lake, Acid red no. 18, Acid black no. 1, Pigment yellow no. 13, Solvent yellow no. 29, Acid red no. 73, Brilliant black no. 1, Acid blue no. 1, Acid blue no. 3, Basic violet no. 14, Basic blue no. 26, Acid green no. 50, Acid red no. 52, Acid violet no. 9, Acid red no. 51, Pigment violet no. 23, Pigment red no. 83, Acid blue no. 62, Acid blue no. 74, Pigment violet no. 19, Pigment blue no. 15, Direct blue no. 86, Pigment green no. 7, Bentonite, Barium sulfate, Calcium sulfate, Carbon black, Iron oxide (orange), Magnesium carbonate, Lactoflavin, Capsanthin, capsorubin, Beetroot red, Anthocyanins, Aluminum stearate, Zinc stearate, Magnesium stearate, Calcium stearate, Bromothymol blue, Bromocresol green, Acid red, Color Index (CI) 195, CI 18736, CI 18820, CI 18965, CI 20040, CI 21108, CI 24790, CI 27755, CI 40215, CI 40820, CI 40825, CI 40850, CI 42080, CI 42090, CI 42100, CI 42170, CI 42520, CI 42735, CI 45220, CI 45396, CI 45405, CI 50325, CI 50420, CI 60724, CI 61585, CI 69800, CI 69825, CI 71105, CI 73000, CI 73385, CI 73915, CI 74100, CI 75100, CI 75125, CI 75135, CI 75300, CI 77002, CI 77015, CI 77220, CI 77267, CI 77268:1, CI 77346, CI 77480, CI 77745, Beta carotene, Annatto, Caramel, Carmine, Chlorophyllin-copper complex, Henna;
(b) dispersing the silicone gel in a dispersant medium selected from the group consisting of hydrocarbon oils, paraffin oil, liquid petroleum jelly, vison oil, turtle oil, soya bean oil, perhydrosqualene, sweet almond oil, calophyllum oil, palm oil, grapeseed oil, sesame oil, maize oil, parleam oil, arara oil, rapeseed oil, sunflower oil, cottonseed oil, apricot oil, castor oil, avocado oil, jojoba oil, olive oil, cereal germ oil; esters of lanolic acid, esters of oleic acid, esters of lauric acid, esters of stearic acid; isopropyl myristate, isopropyl palmitate, butyl stearate, hexyl laurate, diisopropyl adipate, isononyl isononate, 2-ethylhexyl palmitate, 2-hexyldecyl laurate, 2-octyldecyl palmitate, 2-octyldodecyl myristate or lactate, 2-diethylhexyl succinate, diisostearyl malate, glyceryl triisostearate, diglyceryl triisostearate, myristic acid, palmitic acid, stearic acid, behenic acid, oleic acid, linoleic acid, linolenic acid, isostearic acid; cetanol, stearyl alcohol, oleyl alcohol, linoleyl or linolenyl alcohol, isostearyl alcohol or octyl dodecanol; silicone oils, polydimethylsiloxane, phenylated polydimethylsiloxane, polymethylphenylsiloxanes, phenyl trimethicones, phenyl trimethicones substituted with fluorinated aliphatic and/or aromatic groups, phenyl trimethicones substituted with functional groups such as hydroxyl, thiol and/or amine groups; polysiloxanes modified with fatty acids, fatty alcohols or polyoxyalkylenes; fluorinated silicones, perfluorinated oils, vegetable oils, sunflower oil, sesame oil, rapeseed oil, the esters long-chain acids or alcohols having the formula RCOOR′ in which R represents the residue of a higher fatty acid containing from 7 to 19 carbon atoms and R′ represents a hydrocarbon chain containing from 3 to 20 carbon atoms, hydrogenated polyisobutylene, isododecane, volatile isoparaffins, oleyl alcohol, decanol, dodecanol, octadecanol and linoleyl alcohol; and
(c) homogenizing said silicone gel in said dispersant medium.

29. The method of claim 28 wherein the cosmetic is selected from the group consisting of lipsticks, foundations, face powders, eye liners, eye shadows, blushes, makeup, and mascara.

30. The method of claim 28 wherein the silicone gel is a gel formed from a silicone and a hydrosilylation compatible solvent wherein said silicone is prepared by the hydrosilylation of a linear alkenyl polyorganosiloxane and a hydride resin.

31. The method of claim 28 wherein the silicone gel is a gel formed as a reaction product of an epoxy functional hydrido-siloxane said reaction product being formed in an epoxy-gel formation compatible solvent.

32. The method of claim 28 wherein the silicone gel is a gel formed from a silicone and a hydrosilylation compatible solvent wherein said silicone is prepared by the hydrosilylation of a linear hydrogen polyorganosiloxane and an alkenyl resin.

33. The method of claim 28 wherein the silicone gel is a gel formed from a silicone and a hydrosilylation compatible solvent wherein said silicone is prepared by the hydrosilylation of a linear hydrogen polyorganosiloxane and a linear alkenyl polyorganosiloxane.

34. The method of claim 28 wherein the silicone gel is a gel formed from a silicone and hydrosilylation compatible solvent wherein said silicone is prepared by the hydrosilylation of a hydrogen polyorganosiloxane resin and an alkenyl polyorganosiloxane resin.

35. The method of claim 28 wherein the silicone gel is a gel formed from a silicone and a hydrosilylation compatible solvent wherein said silicone is prepared by the hydrosilylation of a linear hydrogen organopolysiloxane having two or more hydride functionalities per molecule and an α,ω reactive organic molecule possessing two or more reactive functionalities per molecule.

36. The method of claim 28 wherein the silicone gel is a gel formed as a reaction product of a vinyl functional hydrido-siloxane in a hydrosilylation compatible solvent.

37. A method for making a cosmetic composition consisting essentially of:
(a) preparing a silicone gel comprising an entrapped or encapsulated pigment; and
(b) dispersing the silicone gel in a dispersant medium; and
(c) homogenizing said silicone gel in said dispersant medium.

38. A method for making a cosmetic composition consisting of:
(a) preparing a silicone gel comprising an entrapped or encapsulated pigment; and
(b) dispersing the silicone gel in a dispersant medium and
(c) homogenizing said silicone gel in said dispersant medium.

39. A method for making a pigmented cosmetic composition comprising:
(a) preparing a silicone gel comprising an entrapped, occluded or encapsulated pigment;
(b) dispersing said gel in a dispersant medium;
(c) homogenizing said silicone gel in said dispersant medium; and
(d) adding thereto a personal care ingredient.

40. The method of claim 39 wherein the silicone gel is selected from the group of gels consisting of:
(i) a gel formed from a silicone and a hydrosilylation compatible solvent wherein said silicone is prepared by the hydrosilylation of a linear alkenyl polyorganosiloxane and a hydride resin;
(ii) a gel formed as a reaction product of an epoxy functional hydrido-siloxane said reaction product being formed in an epoxy-gel formation compatible solvent;
(iii) a gel formed from a silicone and a hydrosilylation compatible solvent wherein said silicone is prepared by the hydrosilylation of a linear hydrogen polyorganosiloxane and an alkenyl resin;
(iv) a gel formed from a silicone and a hydrosilylation compatible solvent wherein said silicone is prepared by the hydrosilylation of a linear hydrogen polyorganosiloxane and a linear alkenyl polyorganosiloxane;
(v) a gel formed from a silicone and hydrosilylation compatible solvent wherein said silicone is prepared by the hydrosilylation of a hydrogen polyorganosiloxane resin and an alkenyl polyorganosiloxane resin;
(vi) a gel formed from a silicone and a hydrosilylation compatible solvent wherein said silicone is prepared by the hydrosilylation of a linear hydrogen organopoly-siloxane having two or more hydride functionalities per molecule and an α,ω reactive organic molecule possessing two or more reactive functionalities per molecule; and
(vii) a gel formed as a reaction product of a vinyl functional hydrido-siloxane in a hydrosilylation compatible solvent.

41. The method of claim 39 wherein the dispersant medium is selected from the group consisting of physiologically acceptable liquid lipophilic or fatty phases and silicone fluids.

42. The method of claim 41 wherein the silicone gel is selected from the group of gels consisting of:
(i) a gel formed from a silicone and a hydrosilylation compatible solvent wherein said silicone is prepared by the hydrosilylation of a linear alkenyl polyorganosiloxane and a hydride resin;
(ii) a gel formed as a reaction product of an epoxy functional hydrido-siloxane said reaction product being formed in an epoxy-gel formation compatible solvent;
(iii) a gel formed from a silicone and a hydrosilylation compatible solvent wherein said silicone is prepared by the hydrosilylation of a linear hydrogen polyorganosiloxane and an alkenyl resin;
(iv) a gel formed from a silicone and a hydrosilylation compatible solvent wherein said silicone is prepared by the hydrosilylation of a linear hydrogen polyorganosiloxane and a linear alkenyl polyorganosiloxane;
(v) a gel formed from a silicone and hydrosilylation compatible solvent wherein said silicone is prepared by the hydrosilylation of a hydrogen polyorganosiloxane resin and an alkenyl polyorganosiloxane resin;
(vi) a gel formed from a silicone and a hydrosilylation compatible solvent wherein said silicone is prepared by the hydrosilylation of a linear hydrogen organopolysiloxane having two or more hydride functionalities per molecule and an α,ω reactive organic molecule possessing two or more reactive functionalities per molecule; and
(vii) a gel formed as a reaction product of a vinyl functional hydridosiloxane in a hydrosilylation compatible solvent.

43. The method of claim 39 wherein the cosmetic is selected from the group consisting of lipsticks, foundations, face powders, eye liners, eye shadows, blushes, makeup, and mascara.

44. The, method of claim 40 wherein the cosmetic is selected from the group consisting of lipsticks, foundations, face powders, eye liners, eye shadows, blushes, makeup, and mascara.

45. The method of claim 41 wherein the cosmetic is selected from the group consisting of lipsticks, foundations, face powders, eye liners, eye shadows, blushes, makeup, and mascara.

46. The method of claim 42 wherein the cosmetic is selected from the group consisting of lipsticks, foundations, face powders, eye liners, eye shadows, blushes, makeup, and mascara.

47. A method for preparing a pigmented cosmetic composition comprising:
(a) preparing a silicone gel comprising an entrapped or encapsulated pigment selected from the group of silicone gels consisting of:
(i) a gel formed from a silicone and a hydrosilylation compatible solvent wherein said silicone is prepared by the hydrosilylation of a linear alkenyl polyorganosiloxane and a hydride resin;
(ii) a gel formed as a reaction product of an epoxy functional hydrido-siloxane said reaction product being formed in an epoxy-gel formation compatible solvent;
(iii) a gel formed from a silicone and a hydrosilylation compatible solvent wherein said silicone is prepared by the hydrosilylation of a linear hydrogen polyorganosiloxane and an alkenyl resin;
(iv) a gel formed from a silicone and a hydrosilylation compatible solvent wherein said silicone is prepared by the hydrosilylation of a linear hydrogen polyorganosiloxane and a linear alkenyl polyorganosiloxane;
(v) a gel formed from a silicone and hydrosilylation compatible solvent wherein said silicone is prepared by the hydrosilylation of a hydrogen polyorganosiloxane resin and an alkenyl polyorganosiloxane resin;
(vi) a gel formed from a silicone and a hydrosilylation compatible solvent wherein said silicone is prepared by the hydrosilylation of a linear hydrogen organopolysiloxane having two or more hydride functionalities per molecule and an α,ω reactive organic molecule possessing two or more reactive functionalities per molecule; and
(vii) a gel formed as a reaction product of a vinyl functional hydrido-siloxane in a hydrosilylation compatible solvent;
wherein said pigment is selected from the group consisting of FD&C blue no. 1, FD&C green no. 3, FD&C red no. 4, FD&C red no. 40, FD&C yellow no. 5, FF&C yellow no. 6, D&C blue no. 4, D&C brown no. 1, D&C green no. 5, D&C green no. 6, D&C green no. 8, D&C orange no. 4, D&C orange no. 5, D&C orange no. 10, D&C orange no. 11, D&C red no. 6, D&C red no. 7, D&C red no. 17, D&C red no. 21, D&C red no. 22, D&C red no. 27, D&C red no. 28, D&C red no. 30, D&C red no. 31, D&C red no. 33, D&C red no. 34, D&C red no. 36, D&C violet no. 2, D&C yellow no. 7, D&C yellow no. 8, D&C yellow no. 10, D&C yellow no. 11, Ext. D&C violet no. 2, Ext. D&C yellow no. 7, Iron oxide (red, yellow, black), Titanium dioxide, Zinc oxide, Ultramarine, Bismuth oxychloride, Chromium oxide green, Chromium hydroxide green, Ferric ferrocyanide, Manganese violet, Guanine, Acid green no. 1, Pigment yellow no. 1, Pigment yellow no. 3, Solvent red no. 3, Solvent red no. 1, Pigment red no. 112, Pigment red no. 5, Acid orange no. 6, Acid red no. 14, Pigment red no. 68, Pigment red no. 48, Acid red no. 27 & Al lake, Acid red no. 18, Acid black no. 1, Pigment yellow no. 13, Solvent yellow no. 29, Acid red no. 73, Brilliant black no. 1, Acid blue no. 1, Acid blue no. 3, Basic violet no. 14, Basic blue no. 26, Acid green no. 50, Acid red no. 52, Acid violet no. 9, Acid red no. 51, Pigment violet no. 23, Pigment red no. 83, Acid blue no. 62, Acid blue no. 74, Pigment violet no. 19, Pigment blue no. 15, Direct blue no. 86, Pigment green no. 7, Bentonite, Barium sulfate, Calcium sulfate, Carbon black, Iron oxide (orange), Magnesium carbonate, Lactoflavin, Capsanthin, capsorubin, Beetroot red, Anthocyanins, Aluminum stearate, Zinc stearate, Magnesium stearate, Calcium stearate, Bromothymol blue, Bromocresol green, Acid red, Color Index (CI) 195, CI 18736, CI 18820, CI 18965, CI 20040, CI 21108, CI 24790, CI 27755, CI 40215, CI 40820, CI 40825, CI 40850, CI 42080, CI 42090, CI 42100, CI 42170, CI 42520, CI 42735, CI 45220, CI 45396, CI 45405, CI 50325, CI 50420, CI 60724, CI 61585, CI 69800, CI 69825, CI 71105, CI 73000, CI 73385, CI 73915, CI 74100, CI 75100, CI 75125, CI 75135, CI 75300, CI 77002, CI 77015, CI 77220, CI 77267, CI 77268:1, CI 77346, CI 77480, CI 77745, Beta carotene, Annatto, Caramel, Carmine, Chlorophyllin-copper complex, Henna;
(b) dispersing the silicone gel in a dispersant medium selected from the group consisting of hydrocarbon oils, paraffin oil, liquid petroleum jelly, vison oil, turtle oil, soya bean oil, perhydrosqualene, sweet almond oil, calophyllum oil, palm oil, grapeseed oil, sesame oil, maize oil, parleam oil, arara oil, rapeseed oil, sunflower oil, cottonseed oil, apricot oil, castor oil, avocado oil, jojoba oil, olive oil, cereal germ oil; esters of lanolic acid, esters of oleic acid, esters of lauric acid, esters of stearic acid; isopropyl myristate, isopropyl palmitate, butyl stearate, hexyl laurate, diisopropyl adipate, isononyl isononate, 2-ethylhexyl palmitate, 2-hexyldecyl laurate, 2-octyldecyl palmitate, 2-octyldodecyl myristate or lactate, 2-diethylhexyl succinate, diisostearyl malate, glyceryl triisostearate, diglyceryl triisostearate, myristic acid, palmitic acid, stearic acid, behenic acid, oleic acid, linoleic acid, linolenic acid, isostearic acid; cetanol, stearyl alcohol, oleyl alcohol, linoleyl or linolenyl alcohol, isostearyl alcohol or octyl dodecanol; silicone oils, polydimethylsiloxane, phenylated polydimethylsiloxane, polymethylphenylsiloxanes, phenyl trimethicones, phenyl trimethicones substituted with fluorinated aliphatic and/or aromatic groups, phenyl trimethicones substituted with functional groups such as hydroxyl, thiol and/or amine groups; polysiloxanes modified with fatty acids, fatty alcohols or polyoxyalkylenes; fluorinated silicones, perfluorinated oils, vegetable oils, sunflower oil, sesame oil, rapeseed oil, the esters long-chain acids or alcohols having the formula RCOOR′ in which R represents the residue of a higher fatty acid containing from 7 to 19 carbon atoms and R′ represents a hydrocarbon chain containing from 3 to 20 carbon atoms, hydrogenated polyisobutylene, isododecane, volatile isoparaffins, oleyl alcohol, decanol, dodecanol, octadecanol and linoleyl alcohol; and
(c) homogenizing said silicone gel in said dispersant medium; and
(d) adding thereto a personal care ingredient.

48. The method of claim 47 wherein the cosmetic is selected from the group consisting of lipsticks, foundations, face powders, eye liners, eye shadows, blushes, makeup, and mascara.

49. The method of claim 47 wherein the silicone gel is a gel formed from a silicone and a hydrosilylation compatible solvent wherein said silicone is prepared by the hydrosilylation of a linear alkenyl polyorganosiloxane and a hydride resin.

50. The method of claim 47 wherein the silicone gel is a gel formed as a reaction product of an epoxy functional hydrido-siloxane said reaction product being formed in an epoxy-gel formation compatible solvent.

51. The method of claim 47 wherein the silicone gel is a gel formed from a silicone and a hydrosilylation compatible solvent wherein said silicone is prepared by the hydrosilylation of a linear hydrogen polyorganosiloxane and an alkenyl resin.

52. The method of claim 47 wherein the silicone gel is a gel formed from a silicone and a hydrosilylation compatible solvent wherein said silicone is prepared by the hydrosilylation of a linear hydrogen polyorganosiloxane and a linear alkenyl polyorganosiloxane.

53. The method of claim 47 wherein the silicone gel is a gel formed from a silicone and hydrosilylation compatible solvent wherein said silicone is prepared by the hydrosilylation of a hydrogen polyorganosiloxane resin and an alkenyl polyorganosiloxane resin.

54. The method of claim 47 wherein the silicone gel is a gel formed from a silicone and a hydrosilylation compatible solvent wherein said silicone is prepared by the hydrosilylation of a linear hydrogen organopolysiloxane having two or more hydride functionalities per molecule and an α,ω reactive organic molecule possessing two or more reactive functionalities per molecule.

55. The method of claim 47 wherein the silicone gel is a gel formed as a reaction product of a vinyl functional hydrido-siloxane in a hydrosilylation compatible solvent.

56. A method for making a cosmetic composition consisting essentially of:
(a) preparing a silicone gel comprising an entrapped or encapsulated pigment;
(b) dispersing the silicone gel in a dispersant medium;
(c) homogenizing said silicone gel in said dispersant medium; and
(d) adding thereto a personal care ingredient..

57. A method for making a cosmetic composition consisting of:
(a) preparing a silicone gel comprising an entrapped or encapsulated pigment;
(b) dispersing the silicone gel in a dispersant medium;
(c) homogenizing said silicone gel in said dispersant medium; and
(d) adding thereto a personal care ingredient.

58. A method for making a pigmented cosmetic composition comprising:
(a) preparing a silicone gel comprising an entrapped, occluded or encapsulated pigment;
(b) dispersing said gel in a dispersant medium;
(c) adding to said silicone gel and said dispersant medium a personal care ingredient; and
(d) homogenizing said silicone gel, said dispersant medium and said personal care ingredient.

59. The method of claim 58 wherein the silicone gel is selected from the group of gels consisting of:
(i) a gel formed from a silicone and a hydrosilylation compatible solvent wherein said silicone is prepared by the hydrosilylation of a linear alkenyl polyorganosiloxane and a hydride resin;
(ii) a gel formed as a reaction product of an epoxy functional hydrido-siloxane said reaction product being formed in an epoxy-gel formation compatible solvent;
(iii) a gel formed from a silicone and a hydrosilylation compatible solvent wherein said silicone is prepared by the hydrosilylation of a linear hydrogen polyorganosiloxane and an alkenyl resin;
(iv) a gel formed from a silicone and a hydrosilylation compatible solvent wherein said silicone is prepared by the hydrosilylation of a linear hydrogen polyorganosiloxane and a linear alkenyl polyorganosiloxane;
(v) a gel formed from a silicone and hydrosilylation compatible solvent wherein said silicone is prepared by the hydrosilylation of a hydrogen polyorganosiloxane resin and an alkenyl polyorganosiloxane resin;
(vi) a gel formed from a silicone and a hydrosilylation compatible solvent wherein said silicone is prepared by the hydrosilylation of a linear hydrogen organopoly-siloxane having two or more hydride functionalities per molecule and an α,ω reactive organic molecule possessing two or more reactive functionalities per molecule; and
(vii) a gel formed as a reaction product of a vinyl functional hydrido-siloxane in a hydrosilylation compatible solvent.

60. The method of claim 58 wherein the dispersant medium is selected from the group consisting of physiologically acceptable liquid lipophilic or fatty phases and silicone fluids.

61. The method of claim 59 wherein the silicone gel is selected from the group of gels consisting of:
(i) a gel formed from a silicone and a hydrosilylation compatible solvent wherein said silicone is prepared by the hydrosilylation of a linear alkenyl polyorganosiloxane and a hydride resin;
(ii) a gel formed as a reaction product of an epoxy functional hydrido-siloxane said reaction product being formed in an epoxy-gel formation compatible solvent;
(iii) a gel formed from a silicone and a hydrosilylation compatible solvent wherein said silicone is prepared by the hydrosilylation of a linear hydrogen polyorganosiloxane and an alkenyl resin;
(iv) a gel formed from a silicone and a hydrosilylation compatible solvent wherein said silicone is prepared by the hydrosilylation of a linear hydrogen polyorganosiloxane and a linear alkenyl polyorganosiloxane;
(v) a gel formed from a silicone and hydrosilylation compatible solvent wherein said silicone is prepared by the hydrosilylation of a hydrogen polyorganosiloxane resin and an alkenyl polyorganosiloxane resin;
(vi) a gel formed from a silicone and a hydrosilylation compatible solvent wherein said silicone is prepared by the hydrosilylation of a linear hydrogen organopolysiloxane having two or more hydride functionalities per molecule and an α,ω reactive organic molecule possessing two or more reactive functionalities per molecule; and
(vii) a gel formed as a reaction product of a vinyl functional hydrido-siloxane in a hydrosilylation compatible solvent.

62. The method of claim 58 wherein the cosmetic is selected from the group consisting of lipsticks, foundations, face powders, eye liners, eye shadows, blushes, makeup, and mascara.

63. The method of claim 59 wherein the cosmetic is selected from the group consisting of lipsticks, foundations, face powders, eye liners, eye shadows, blushes, makeup, and mascara.

64. The method of claim 60 wherein the cosmetic is selected from the group consisting of lipsticks, foundations, face powders, eye liners, eye shadows, blushes, makeup, and mascara.

65. The method of claim 61 wherein the cosmetic is selected from the group consisting of lipsticks, foundations, face powders, eye liners, eye shadows, blushes, makeup, and mascara.

66. A method for preparing a pigmented cosmetic composition comprising:
(a) preparing a silicone gel comprising an entrapped or encapsulated pigment selected from the group of silicone gels consisting of:
(i) a gel formed from a silicone and a hydrosilylation compatible solvent wherein said silicone is prepared by the hydrosilylation of a linear alkenyl polyorganosiloxane and a hydride resin;
(ii) a gel formed as a reaction product of an epoxy functional hydrido-siloxane said reaction product being formed in an epoxy-gel formation compatible solvent;
(iii) a gel formed from a silicone and a hydrosilylation compatible solvent wherein said silicone is prepared by the hydrosilylation of a linear hydrogen polyorganosiloxane and an alkenyl resin;
(iv) a gel formed from a silicone and a hydrosilylation compatible solvent wherein said silicone is prepared by the hydrosilylation of a linear hydrogen polyorganosiloxane and a linear alkenyl polyorganosiloxane;
(v) a gel formed from a silicone and hydrosilylation compatible solvent wherein said silicone is prepared by the hydrosilylation of a hydrogen polyorganosiloxane resin and an alkenyl polyorganosiloxane resin;
(vi) a gel formed from a silicone and a hydrosilylation compatible solvent wherein said silicone is prepared by the hydrosilylation of a linear hydrogen organopolysiloxane having two or more hydride functionalities per molecule and an α,ω reactive organic molecule possessing two or more reactive functionalities per molecule; and
(vii) a gel formed as a reaction product of a vinyl functional hydrido-siloxane in a hydrosilylation compatible solvent;
wherein said pigment is selected from the group consisting of FD&C blue no. 1, FD&C green no. 3, FD&C red no. 4, FD&C red no. 40, FD&C yellow no. 5, FF&C yellow no. 6, D&C blue no. 4, D&C brown no. 1, D&C green no. 5, D&C green no. 6, D&C green no. 8, D&C orange no. 4, D&C orange no. 5, D&C orange no. 10, D&C orange no. 11, D&C red no. 6, D&C red no. 7, D&C red no. 17, D&C red no. 21, D&C red no. 22, D&C red no. 27, D&C red no. 28, D&C red no. 30, D&C red no. 31, D&C red no. 33, D&C red no. 34, D&C red no. 36, D&C violet no. 2, D&C yellow no. 7, D&C yellow no. 8, D&C yellow no. 10, D&C yellow no. 11, Ext. D&C violet no. 2, Ext. D&C yellow no. 7, Iron oxide (red, yellow, black), Titanium dioxide, Zinc oxide, Ultramarine, Bismuth oxychloride, Chromium oxide green, Chromium hydroxide green, Ferric ferrocyanide, Manganese violet, Guanine, Acid green no. 1, Pigment yellow no. 1, Pigment yellow no. 3, Solvent red no. 3, Solvent red no. 1, Pigment red no. 112, Pigment red no. 5, Acid orange no. 6, Acid red no. 14, Pigment red no. 68, Pigment red no. 48, Acid red no. 27 & Al lake, Acid red no. 18, Acid black no. 1, Pigment yellow no. 13, Solvent yellow no. 29, Acid red no. 73, Brilliant black no. 1, Acid blue no. 1, Acid blue no. 3, Basic violet no. 14, Basic blue no. 26, Acid green no. 50, Acid red no. 52, Acid violet no. 9, Acid red no. 51, Pigment violet no. 23, Pigment red no. 83, Acid blue no. 62, Acid blue no. 74, Pigment violet no. 19, Pigment blue no. 15, Direct blue no. 86, Pigment green no. 7, Bentonite, Barium sulfate, Calcium sulfate, Carbon black, Iron oxide (orange), Magnesium carbonate, Lactoflavin, Capsanthin, capsorubin, Beetroot red, Anthocyanins, Aluminum stearate, Zinc stearate, Magnesium stearate, Calcium stearate, Bromothymol blue, Bromocresol green, Acid red, Color Index (CI) 195, CI 18736, CI 18820, CI 18965, CI 20040, CI 21108, CI 24790, CI 27755, CI 40215, CI 40820, CI 40825, CI 40850, CI 42080, CI 42090, CI 42100, CI 42170, CI 42520, CI 42735, CI 45220, CI 45396, CI 45405, CI 50325, CI 50420, CI 60724, CI 61585, CI 69800, CI 69825, CI 71105, CI 73000, CI 73385, CI 73915, CI 74100, CI 75100, CI 75125, CI 75135, CI 75300, CI 77002, CI 77015, CI 77220, CI 77267, CI 77268:1, CI 77346, CI 77480, CI 77745, Beta carotene, Annatto, Caramel, Carmine, Chlorophyllin-copper complex, Henna;
(b) dispersing the silicone gel in a dispersant medium selected from the group consisting of hydrocarbon oils, paraffin oil, liquid petroleum jelly, vison oil, turtle oil, soya bean oil, perhydrosqualene, sweet almond oil, calophyllum oil, palm oil, grapeseed oil, sesame oil, maize oil, parleam oil, arara oil, rapeseed oil, sunflower oil, cottonseed oil, apricot oil, castor oil, avocado oil, jojoba oil, olive oil, cereal germ oil; esters of lanolic acid, esters of oleic acid, esters of lauric acid, esters of stearic acid; isopropyl myristate, isopropyl palmitate, butyl stearate, hexyl laurate, diisopropyl adipate, isononyl isononate, 2-ethylhexyl palmitate, 2-hexyldecyl laurate, 2-octyldecyl palmitate, 2-octyldodecyl myristate or lactate, 2-diethylhexyl succinate, diisostearyl malate, glyceryl triisostearate, diglyceryl triisostearate, myristic acid, palmitic acid, stearic acid, behenic acid, oleic acid, linoleic acid, linolenic acid, isostearic acid; cetanol, stearyl alcohol, oleyl alcohol, linoleyl or linolenyl alcohol, isostearyl alcohol or octyl dodecanol; silicone oils, polydimethylsiloxane, phenylated polydimethylsiloxane, polymethylphenylsiloxanes, phenyl trimethicones, phenyl trimethicones substituted with fluorinated aliphatic and/or aromatic groups, phenyl trimethicones substituted with functional groups such as hydroxyl, thiol and/or amine groups; polysiloxanes modified with fatty acids, fatty alcohols or polyoxyalkylenes; fluorinated silicones, perfluorinated oils, vegetable oils, sunflower oil, sesame oil, rapeseed oil, the esters long-chain acids or alcohols having the formula RCOOR′ in which R represents the residue of a higher fatty acid containing from 7 to 19 carbon atoms and R′ represents a hydrocarbon chain containing from 3 to 20 carbon atoms, hydrogenated polyisobutylene, isododecane, volatile isoparaffins, oleyl alcohol, decanol, dodecanol, octadecanol and linoleyl alcohol;
(c) adding to said silicone gel and said dispersant medium a personal care ingredient; and
(d) homogenizing said silicone gel, said dispersant medium and said personal care ingredient.

67. The method of claim 66 wherein the cosmetic is selected from the group consisting of lipsticks, foundations, face powders, eye liners, eye shadows, blushes, makeup, and mascara.

68. The method of claim 66 wherein the silicone gel is a gel formed from a silicone and a hydrosilylation compatible solvent wherein said silicone is prepared by the hydrosilylation of a linear alkenyl polyorganosiloxane and a hydride resin.

69. The method of claim 66 wherein the silicone gel is a gel formed as a reaction product of an epoxy functional hydrido-siloxane said reaction product being formed in an epoxy-gel formation compatible solvent.

70. The method of claim 66 wherein the silicone gel is a gel formed from a silicone and a hydrosilylation compatible solvent wherein said silicone is prepared by the hydrosilylation of a linear hydrogen polyorganosiloxane and an alkenyl resin.

71. The method of claim 66 wherein the silicone gel is a gel formed from a silicone and a hydrosilylation compatible solvent wherein said silicone is prepared by the hydrosilylation of a linear hydrogen polyorganosiloxane and a linear alkenyl polyorganosiloxane.

72. The method of claim 66 wherein the silicone gel is a gel formed from a silicone and hydrosilylation compatible solvent wherein said silicone is prepared by the hydrosilylation of a hydrogen polyorganosiloxane resin and an alkenyl polyorganosiloxane resin.

73. The method of claim 66 wherein the silicone gel is a gel formed from a silicone and a hydrosilylation compatible solvent wherein said silicone is prepared by the hydrosilylation of a linear hydrogen organopolysiloxane having two or more hydride functionalities per molecule and an α,ω to reactive organic molecule possessing two or more reactive functionalities per molecule.

74. The method of claim 66 wherein the silicone gel is a gel formed as a reaction product of a vinyl functional hydrido-siloxane in a hydrosilylation compatible solvent.

75. A method for making a cosmetic composition consisting essentially of:
(a) preparing a silicone gel comprising an entrapped or encapsulated pigment;
(b) dispersing the silicone gel in a dispersant medium;
(c) adding to said silicone gel and said dispersant medium a personal care ingredient; and
(d) homogenizing said silicone gel, said dispersant medium and said personal care ingredient.

76. A method for making a cosmetic composition consisting of:
(a) preparing a silicone gel comprising an entrapped or encapsulated pigment;
(b) dispersing the silicone gel in a dispersant medium;
(c) adding to said silicone gel and said dispersant medium a personal care ingredient; and
(d) homogenizing said silicone gel, said dispersant medium and said personal care ingredient.
